(19) United States
(12) Patent Application Publication
(10) Pub. No.: US 2025/0307584 A1
(43) Pub. Date: Oct. 2, 2025

(54) INFORMATION PROCESSING DEVICE, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Shinichi TSURUYAMA, SHIOJIRI-SHI (JP)

(21) Appl. No.: 19/091,234

(22) Filed: Mar. 26, 2025

(30) Foreign Application Priority Data
Mar. 28, 2024 (JP) 2024-053126

(51) Int. Cl. G06K 15/02; G06K 15/00; G06T 11/20

(52) U.S. Cl. CPC G06K 15/1859; G06K 15/007; G06T 11/20

(57) ABSTRACT

An information processing device includes an instruction information acquisition unit configured to acquire first print instruction information including designation of a drawing target, an image request unit configured to, when an image corresponding to the acquired first print instruction information is not stored in a storage, request, using the first print instruction information, another server to transmit an image in which the drawing target is drawn, an image acquisition unit configured to acquire the image from the other server, and a print control unit configured to cause an image forming device to print the acquired image.

The present application is based on, and claims priority from JP Application Serial Number 2024-053126, filed Mar. 28, 2024, the disclosure of which is hereby incorporated by reference herein in its entirety.

### BACKGROUND

### 1. Technical Field

The present disclosure relates to an information processing device, an information processing method, and a non-transitory computer-readable storage medium storing a program.

### 2. Related Art

A system for providing a print to a user is known. For example, JP-A-2020-56913 discloses a printing system that performs printing according to voice input from a user.

JP-A-2020-56913 is an example of the related art.

If the printing system is capable of acquiring an image matching a desire of the user from another device, it is possible to print various image contents. However, when processing of acquiring the image matching the desire of the user takes time, the user is kept waiting for a long time.

### SUMMARY

According to an aspect of the present disclosure, there is provided an information processing device including: an instruction information acquisition unit configured to acquire first print instruction information including designation of a drawing target; an image request unit configured to, when an image corresponding to the acquired first print instruction information is not stored in a storage, request, using the first print instruction information, another server to transmit an image in which the drawing target is drawn; an image acquisition unit configured to acquire the image from the other server; and a print control unit configured to cause an image forming device to print the acquired image.

According to an aspect of the present disclosure, there is provided an information processing method including; acquiring first print instruction information including designation of a drawing target; when an image corresponding to the acquired first print instruction information is not stored in a storage, requesting, using the first print instruction information, another server to transmit an image in which the drawing target is drawn; acquiring the image from the other server; and causing an image forming device to print the acquired image.

According to an aspect of the present disclosure, there is provided a non-transitory computer-readable storage medium storing a program, the program causing a computer to execute: an instruction information acquisition step of acquiring first print instruction information including designation of a drawing target; an image request step of, when an image corresponding to the acquired first print instruction information is not stored in a storage, requesting, using the first print instruction information, another server to transmit an image in which the drawing target is drawn; an image acquisition step of acquiring the image from the other server; and a print control step of causing an image forming device to print the acquired image.

### BRIEF DESCRIPTION OF THE DRAWINGS

FIG. 1 is a block diagram illustrating an example of a configuration of a printing system according to an embodiment.

FIG. 2 is a block diagram illustrating an example of a configuration of an information processing device according to the embodiment.

FIG. 3A is a sequence chart illustrating an example of a flow of processing executed in the printing system according to the embodiment.

FIG. 3B is a sequence chart illustrating the example of the flow of the processing executed in the printing system according to the embodiment.

FIG. 4A is a sequence chart illustrating another example of the flow of the processing executed in the printing system according to the embodiment.

FIG. 4B is a sequence chart illustrating the other example of the flow of the processing executed in the printing system according to the embodiment.

FIG. 4C is a sequence chart illustrating the other example of the flow of the processing executed in the printing system according to the embodiment.

FIG. 5 is a schematic diagram illustrating an example of a list generated by a list output unit.

FIG. 6 is a block diagram illustrating an example of a configuration of a printing system according to a modification 1.

FIG. 7A is a sequence chart illustrating an example of a flow of processing executed in the printing system according to the modification 1.

FIG. 7B is a sequence chart illustrating the example of the flow of the processing executed in the printing system according to the modification 1.

FIG. 7C is a sequence chart illustrating the example of the flow of the processing executed in the printing system according to the modification 1.

FIG. 8 is a schematic diagram illustrating an example of a list generated by the list output unit.

FIG. 9A is a sequence chart illustrating an example of a flow of processing executed in a printing system according to a modification 2.

FIG. 9B is a sequence chart illustrating the example of the flow of the processing executed in the printing system according to the modification 2.

FIG. 10 is a sequence chart illustrating an example of a flow of processing executed in the printing system according to the modification 2.

FIG. 11 is a sequence chart illustrating an example of a flow of processing executed in a printing system according to a modification 3.

FIG. 12 is a sequence chart illustrating an example of a flow of processing executed in the printing system according to the modification 3.

### DESCRIPTION OF EMBODIMENTS

Embodiments and the like are explained below with reference to the drawings. To clarify the explanation, the following description and the drawings are omitted and simplified as appropriate. In the drawings, the same elements are denoted by the same reference numerals and signs and redundant explanation of the elements is omitted according to necessity.

As explained above, when an image matching a desire of the user is acquired from another device, processing for acquiring the image matching the desire of the user sometimes takes time and the user is kept waiting for a long time. Thus, in the present disclosure (in particular, a modification 2 explained after the embodiment), a printing system capable of, by limiting implementation of processing of acquiring an image from another device, reducing the number of times a user is kept waiting for a long time. In the present disclosure, first, the following embodiment is explained as a technique relating to a technique for solving the problems described above.

### EMBODIMENT

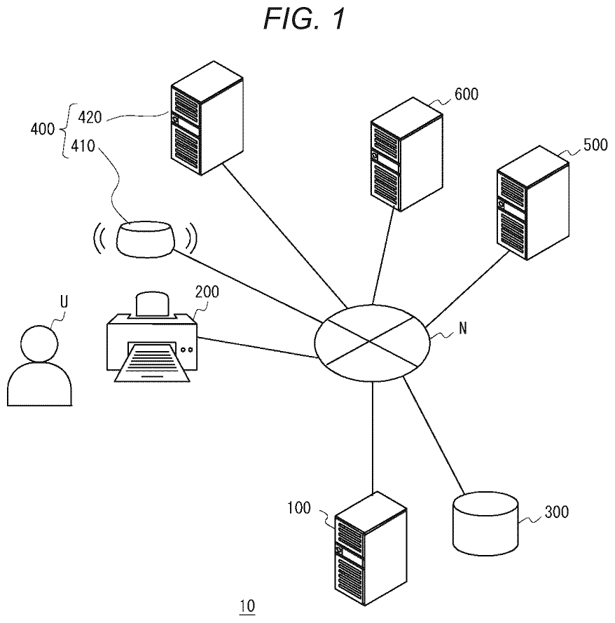

FIG. 1 is a block diagram illustrating an example of a configuration of a printing system 10 according to an embodiment. In the example illustrated in FIG. 1, the printing system 10 includes an information processing device 100, an image forming device 200, a storage 300, a voice input/output device 410, a voice processing server 420, an image generation AI server 500, and a text generation AI server 600. The information processing device 100, the image forming device 200, the storage 300, the voice input/output device 410, the voice processing server 420, the image generation AI server 500, and the text generation AI server 600 are connected to a network N such as the Internet. A user U illustrated in FIG. 1 is a user who desires printing of an image by the image forming device 200. Although one user U is illustrated in FIG. 1, a plurality of users can use the printing system 10.

The information processing device 100 is a device that performs, based on an instruction from the user U, processing of causing the image forming device 200 to print an image. The information processing device 100 is, for example, a server but is not limited to the server and may be any device having functions of a computer. The information processing device 100 may be configured by a plurality of computers (a plurality of servers). Details of the information processing device 100 are explained below.

The image forming device 200 is a device having a function of performing print processing and is specifically, for example, a printer. The image forming device 200 is registered in advance in the information processing device 100 as an image forming device used for printing. Although one image forming device 200 is illustrated in FIG. 1, a plurality of image forming devices 200 may be registered in the information processing device 100 as image forming devices usable for printing. For example, the image forming device 200 may be registered in the information processing device 100 for each of users. In the present embodiment, the information processing device 100 causes the image forming device 200 correlated with an account (identification information) of the user U to execute printing based on an instruction of the user U.

The storage 300 is a storage that stores an image acquired by the information processing device 100 and information relating to the image. In the present embodiment, the storage 300 is specifically a cloud storage that stores data but may not always be configured as the cloud storage. For example, the storage 300 only has to be communicably connected to the information processing device 100 and may not always be connected to the network N. The storage 300 may be incorporated in the information processing device 100.

The voice input/output device 410 is a device that acquires voice from the user U and outputs voice to the user U. The voice input/output device 410 is, for example, a device including a microphone and a speaker. Specifically, the voice input/output device 410 is, for example, a smart speaker but may be, for example, a smartphone or a tablet terminal. The voice input/output device 410 transmits voice data of the user U to the voice processing server 420. The voice input/output device 410 outputs, as voice, voice data transmitted from the voice processing server 420. When a plurality of users use the printing system 10, the printing system 10 can include a plurality of voice input/output devices 410.

The voice processing server 420 performs publicly-known voice recognition processing to acquire an instruction included in voice uttered by the user U. In the present embodiment, the voice processing server 420 acquires an instruction concerning processing of the printing system 10. For example, the voice processing server 420 acquires an instruction of the user U by extracting, from the voice of the user U, a keyword that can relate to the processing of the printing system 10. The voice processing server 420 transmits the acquired instruction to the information processing device 100 as instruction information. The voice processing server 420 may transmit the instruction information of the user U including identification information of the user U registered in advance in the voice processing server 420 to the information processing device 100.

The voice processing server 420 acquires text data, which is data of a sentence to be output by voice from the voice input/output device 410, from the information processing device 100. The voice processing server 420 converts the acquired text data into voice data and transmits the voice data to the voice input/output device 410. Accordingly, the voice input/output device 410 outputs, by voice, the sentence transmitted by the information processing device 100. The voice processing server 420 may be configured by a plurality of servers.

In the present disclosure, the voice input/output device 410 and the voice processing server 420 are collectively referred to as voice system 400.

Both of the image generation AI server 500 and the text generation AI server 600 are servers that provides a so-called generative artificial intelligence (AI) service.

The image generation AI server 500 is a server that provides a service of the image generation AI. The image generation AI server 500 generates an image using an image generation model learned by machine learning such as deep learning. When acquiring an image generation instruction called prompt, the image generation AI server 500 generates an image using the image generation model based on the acquired image generation instruction. In the present embodiment, the image generation AI server 500 generates an image based on an image generation instruction transmitted from the information processing device 100 and transmits the generated image to the information processing device 100. The image generation AI server 500 may provide a publicly-known image generation AI service. The image generation AI server 500 may be configured by a plurality of servers. The printing system 10 may include a plurality of image generation AI servers 500 that provide image generation AI services different from one another. In this case, the information processing device 100 may transmit the image generation instruction to any one image generation AI server 500 selected out of the plurality of image generation AI servers 500.

The text generation AI server 600 is a server that provides a service of the text generation AI. The text generation AI server 600 generates text using a large language model (LLM) learned by machine learning such as deep learning. When acquiring a text generation instruction called prompt, the text generation AI server 600 generates text using the LLM based on the acquired text generation instruction. In the present embodiment, the text generation AI server 600 generates text based on the text generation instruction transmitted from the information processing device 100 and transmits the generated text to the information processing device 100. The text generation AI server 600 may provide a publicly-known text generation AI service. The text generation AI server 600 may be configured by a plurality of servers. The printing system 10 may include a plurality of text generation AI servers 600 that provide text generation AI services different from one another. In this case, the information processing device 100 may transmit the text generation instruction to any one text generation AI server 600 selected out of the plurality of text generation AI servers 600.

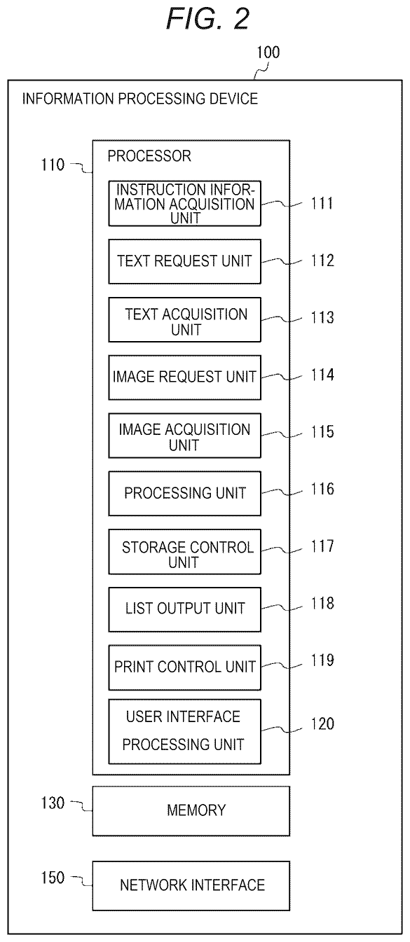

Subsequently, a specific configuration and processing of the information processing device 100 are explained. FIG. 2 is a block diagram illustrating an example of a configuration of the information processing device 100. As illustrated in FIG. 2, the information processing device 100 includes a processor 110, a memory 130, and a network interface 150. As explained above, the information processing device 100 includes functions of a computer.

The network interface 150 is used to communicate via the network N. The network interface 150 may include, for example, a network interface card (NIC).

The memory 130 is configured by, for example, a combination of a volatile memory and a nonvolatile memory. The memory 130 is used to store a program to be executed by the processor 110 and data and the like used for various kinds of processing.

The processor 110 reads a program from the memory 130 and executes the program. Accordingly, the processor 110 implements functions of an instruction information acquisition unit 111, a text request unit 112, a text acquisition unit 113, an image request unit 114, an image acquisition unit 115, a processing unit 116, a storage control unit 117, a list output unit 118, a print control unit 119, and a user interface processing unit 120 explained below. The processor 110 may be, for example, a microprocessor, a microprocessor unit (MPU), or a central processing unit (CPU). The processor 110 may include a plurality of processors.

In the following explanation, the instruction information acquisition unit 111, the text request unit 112, the text acquisition unit 113, the image request unit 114, the image acquisition unit 115, the processing unit 116, the storage control unit 117, the list output unit 118, the print control unit 119, and the user interface processing unit 120 are explained.

The instruction information acquisition unit 111 acquires instruction information that is information indicating an instruction of the user U to the printing system 10. The instruction information acquisition unit 111 may acquire the instruction information of the user U together with identification information of the user U. In the present embodiment, the instruction information acquisition unit 111 acquires instruction information input by the user as voice through the voice system 400. For this reason, the user U does not need to manually operate an input device such as a keyboard or a pointing device, a button of an operation panel, or the like. Therefore, convenience is improved.

Specifically, the instruction information acquisition unit 111 acquires print instruction information that is instruction information including designation of a drawing target and instructing printing. For example, when instructing the printing system 10 to print an image, the user U inputs a key word (for example, “print”) for instructing printing and a keyword (for example, “fox”, “raccoon dog”, or “autumn fruit”) for designating a target desired to be drawn in an image printed by the image forming device 200 to the printing system 10 by voice. The information input to the printing system 10 in this way is acquired by the instruction information acquisition unit 111 as print instruction information.

The print instruction information may include information other than the designation of the drawing target. For example, the print instruction information may include designation of a drawing mode. Here, the designation of the drawing mode refers to designating how to draw the drawing target. For example, as the designation of the drawing mode, it may be designated to draw the drawing target as a coloring picture, a type of a line (for example, crayon, black, pen, or the like) for drawing the drawing target may be designated, and it may be designated what effect (for example, blurring effect or sharp effect) is applied to draw the drawing target.

The instruction information acquisition unit 111 can acquire not only the print instruction information but also any instruction information of the user U. In the present embodiment, the instruction information acquisition unit 111 acquires selection instruction information that is instruction information including an instruction to select a print target out of a plurality of different images listed in a list created by the list output unit 118 explained below. For example, when the list in which the plurality of different images are listed is output, the user U performs, to the printing system 10, voice input for selecting an image to be printed out of these images. The information input to the printing system 10 in this way is acquired by the instruction information acquisition unit 111 as the selection instruction information. The instruction information acquisition unit 111 may acquire instruction information for requesting output of the list explained above.

The image request unit 114 performs processing of requesting an image from a device different from the information processing device 100. In the present embodiment, the image request unit 114 performs processing of requesting an image from the image generation AI server 500. Specifically, the image request unit 114 transmits an image generation instruction generated based on the print instruction information acquired by the instruction information acquisition unit 111 to the image generation AI server 500.

The image generation instruction is an instruction for instructing the image generation AI server 500 to generate an image and is a sentence called prompt. For example, the image request unit 114 generates an image generation instruction (a prompt) for instructing the image generation AI server 500 to generate an image in which a drawing target designated by the print instruction information is drawn and transmits the image generation instruction to the image generation AI server 500. When the print instruction information includes designation of a drawing mode as well, the image request unit 114 generates an image generation instruction (a prompt) for instructing the image generation AI server 500 to generate an image in which the drawing target designated by the print instruction information is drawn in the drawing mode designated by the print instruction information and transmits the image generation instruction to the image generation AI server 500. As explained above, the image request unit 114 may transmit the image generation instruction generated based on the designation of the drawing target and the designation of the drawing mode to the image generation AI server. Accordingly, it is possible to easily acquire an image in which the designated drawing target is drawn in the designated drawing mode.

As explained above, the printing system 10 may include a plurality of image generation AI servers 500 that provide image generation AI services different from one another. In this case, the image request unit 114 transmits an image generation instruction to the selected image generation AI server 500 among the plurality of image generation AI servers 500. When any one of the plurality of image generation AI servers 500 providing different image generation AI services is selected, the image generation AI server 500 (that is, the image generation AI service) may be selected according to setting information for setting an operation of the information processing device 100 stored in advance in the memory 130 or the like. This selection may be performed according to an instruction from the user U. When the image generation AI server 500 (the image generation AI service) is selected according to the instruction from the user U, information for specifying an image generation AI service to be used may be included in the print instruction information acquired from the user U. As explained above, the image request unit 114 may transmit the image generation instruction to the selected image generation AI server 500 among the plurality of different image generation AI servers 500. Accordingly, it is possible to select a service to be used from various image generation AI services and convenience is improved.

The image request unit 114 may request, from the image generation AI server 500, a plurality of different images in which a designated drawing target is drawn. In this case, the image request unit 114 transmits an image generation instruction for instructing to generate a plurality of different images to the image generation AI server 500. When the instruction information acquisition unit 111 acquires instruction information for requesting output of a list in which a plurality of different images are listed, the image request unit 114 may request a plurality of different images from the image generation AI server 500 or may request a plurality of different images regardless of whether such instruction information is acquired.

As explained above, the image request unit 114 may generate the image generation instruction. However, the image generation instruction may be generated by the text generation AI server 600. As components for transmitting the image generation instruction generated by the text generation AI server 600 to the image generation AI server 500, in the present embodiment, the information processing device 100 includes the text request unit 112 and the text acquisition unit 113. When the image generation instruction is generated by the text generation AI server 600, the image request unit 114 does not need to perform generation processing for the image generation instruction.

The text request unit 112 performs processing of requesting text from the text generation AI server 600. Specifically, the text request unit 112 generates a text generation instruction based on the print instruction information acquired by the instruction information acquisition unit 111.

The text generation instruction is an instruction for instructing the text generation AI server 600 to generate text and is a sentence called prompt. More specifically, the text request unit 112 generates a text generation instruction for instructing the text generation AI server 600 to generate an image generation instruction (a prompt) for instructing the image generation AI server 500 to generate an image in which a drawing target designated by the print instruction information is drawn. When the print instruction information also includes designation of a drawing mode, the text request unit 112 generates a text generation instruction for instructing the text generation AI server 600 to generate an image generation instruction (a prompt) for instructing the image generation AI server 500 to generate an image in which the drawing target designated by the print instruction information is drawn in the drawing mode designated by the print instruction information.

The text generation instruction preferably includes information for specifying an image generation AI service provided by the image generation AI server 500 that is a transmission destination of the generated image generation instruction. That is, it is preferable that a prompt for which image generation AI service should be generated is designated in the text generation instruction. Generally, when an image generation AI service is different, a format of a prompt appropriate for obtaining a desired image is also different. In order to generate an appropriate prompt corresponding to an image generation AI service to be used, the text request unit 112 preferably generates a text generation instruction including information for specifying the image generation AI service.

When it is necessary to generate a plurality of different images, the text request unit 112 generates a text generation instruction for instructing the text generation AI server 600 to generate an image generation instruction for instructing the image generation AI server 500 to generate a plurality of different images.

The text request unit 112 transmits the generated text generation instruction to the text generation AI server 600.

As explained above, the printing system 10 may include a plurality of text generation AI servers 600 that provide text generation AI services different from one another. In this case, the text request unit 112 transmits a text generation instruction to the selected text generation AI server 600 among the plurality of text generation AI servers 600. When any one is selected out of the plurality of text generation AI servers 600 providing the different text generation AI services, the text generation AI server 600 (that is, the text generation AI service) may be selected according to setting information for setting an operation of the information processing device 100 stored in advance in the memory 130 or the like. This selection may be performed according to an instruction from the user U. When the text generation AI server 600 (the text generation AI service) is selected according to an instruction from the user U, information for specifying a text generation AI service to be used may be included in print instruction information acquired from the user U. As explained above, the text request unit 112 may transmit the text generation instruction to the selected text generation AI server 600 among the plurality of different text generation AI servers 600. Accordingly, it is possible to select a service to be used from various text generation AI services and convenience is improved.

When the text generation instruction is transmitted from the information processing device 100, the text generation AI server 600 generates, based on the received text generation instruction, text of an image generation instruction for instructing the image generation AI server 500 to generate an image in which a drawing target designated by the print instruction information is drawn. The text generation AI server 600 may generate an image generation instruction of a second natural language (English) based on a text generation instruction of a first natural language (Japanese).

After generating the text of the image generation instruction, the text generation AI server 600 transmits the generated text to the information processing device 100 that is a transmission source of the text generation instruction. Then, the information processing device 100 receives the text. That is, the text acquisition unit 113 acquires, from the text generation AI server 600, the text generated by the text generation AI server 600 based on the text generation instruction transmitted by the text request unit 112. Thereafter, the image request unit 114 transmits the text generated by the text generation AI server 600 to the image generation AI server 500 as an image generation instruction.

In general, content of an image generated by an image generation AI service depends on an image generation instruction (a prompt). Therefore, in order to cause the image generation AI server 500 to generate a better image, it is necessary to transmit an appropriate image generation instruction to the image generation AI server 500. In order to transmit the appropriate image generation instruction, it is required to generate an image generation instruction in which not only information included in print instruction information but also information for complementing the information included in the print instruction information is described in a format corresponding to the image generation AI service. Here, the information for complementing the information included in the instruction information is, for example, a negative prompt for designating a target that should not be drawn or a drawing mode that should be avoided, information for designating a composition, and a parameter for controlling a format of an image such as an image size. It is difficult to generate, on a rule basis, an image generation instruction in which these various kinds of information are described according to a format corresponding to an image generation AI service. In particular, when information is acquired by voice input of a user, since free input by the user is allowed compared with, for example, input of an instruction by operation of a button, it is more difficult to generate a more appropriate image generation instruction on a rule basis. Further, when various image generation AI services can be used, an appropriate format is different and information that should be complemented is different depending on an image generation AI service. This also makes it difficult to generate a more appropriate image generation instruction on a rule basis. In contrast, by causing the text generation AI server 600 to generate an image generation instruction, it is possible to easily acquire an appropriate image generation instruction.

In the image generation using the image generation AI service, an image is generated even if an appropriate image generation instruction is not given. For this reason, the information processing device 100 may not necessarily use the image generation instruction generated by the text generation AI server 600. That is, an image generation instruction generated by the image request unit 114 may be transmitted to the image generation AI server 500. In this case, the information processing device 100 may not include the text request unit 112 and the text acquisition unit 113.

When the image generation instruction is transmitted from the information processing device 100, the image generation AI server 500 generates an image based on the received image generation instruction. After generating the image, the image generation AI server 500 transmits the generated image to the information processing device 100 that is a transmission source of the image generation instruction. Then, the information processing device 100 receives the image. That is, the image acquisition unit 115 acquires, from the image generation AI server 500, the image generated by the image generation AI server 500 based on the image generation instruction. When the image generation AI server 500 generates a plurality of different images based on the image generation instruction, the image acquisition unit 115 acquires a plurality of different images as images in which a designated drawing target is drawn. As explained above, in the present embodiment, since an image conforming to a desire of the user U is acquired using the image generation AI server 500, various images can be provided to the user U. For this reason, compared with when an image can be selected only from image contents prepared in advance in the printing system, it is possible to prevent the user from being tired of the image contents. For this reason, it is possible to print an image that satisfies the user.

The processing unit 116 performs, according to necessity, image processing corresponding to a drawing mode designated by print instruction information. In the present embodiment, when the print instruction information includes designation of a drawing mode in addition to designation of a drawing target, when an image acquired by the image acquisition unit 115 is an image in which the drawing target is not drawn in the drawing mode, the processing unit 116 performs image processing corresponding to the drawing mode designated by the print instruction information. For example, when the image request unit 114 transmits an image generation instruction generated based on only designation of a drawing target to the image generation AI server 500, the processing unit 116 may perform image processing corresponding to the drawing mode designated by the print instruction information. When the image generation AI server 500 (image generation AI service) to be used does not have a function of drawing in the designated drawing mode, the processing unit 116 may perform the image processing corresponding to the drawing mode designated by the print instruction information.

The image processing performed by the processing unit 116 is, for example, processing of converting an image in which the drawing target is drawn in a mode other than the designated drawing mode into an image in which the drawing target is drawn in the designated drawing mode. Specifically, for example, when it is designated to draw the drawing target as a painting as the designation of the drawing mode, the processing unit 116 performs binarization processing and edge extraction processing as the image processing. The image processing is not limited to this and may be processing of changing a line type or processing of applying an effect. Since the processing unit 116 is provided, even when the image acquired by the image acquisition unit 115 is an image in which the drawing target is not drawn in a drawing mode designated by the user, it is possible to obtain an image in which the drawing target is drawn in the drawing mode designated by the user.

The storage control unit 117 performs processing of storing the image acquired by the image acquisition unit 115 in the storage 300. When the image processing is performed by the processing unit 116, the storage control unit 117 may cause the storage 300 to store an image generated by the image processing.

The storage control unit 117 may cause the storage 300 to store other information in correlation with the image. For example, the storage control unit 117 may cause the storage 300 to store the image and print instruction information used to acquire the image in correlation with each other. The storage control unit 117 may cause the storage 300 to store, in correlation with each other, the image and identification information of the user U who has given the instruction indicated by the print instruction information used to acquire the image. The storage control unit 117 may cause the storage 300 to store a list generated by the list output unit 118 explained below.

The list output unit 118 performs processing of outputting a list in which a plurality of different images are listed as print candidates. In the present embodiment, when the image acquisition unit 115 acquires a plurality of different images as images in which the designated drawing target is drawn, the list output unit 118 performs processing of outputting a list in which the plurality of different images are listed as print candidates. This list is used by the user U to check an image before printing is executed.

In the present embodiment, the list output unit 118 generates a list in which a plurality of different images are listed as print candidates and requests the print control unit 119 to perform print processing for the list in order to print out the generated list with the image forming device 200. The list output unit 118 only has to perform processing of outputting the list and may not always perform processing of printing out the list. For example, the list output unit 118 may perform processing of outputting and displaying the list on a display of a terminal device of the user U. Since the list in which the plurality of images are listed is output, the user U can check an image of a print candidate. Therefore, convenience is improved.

The print control unit 119 performs processing of causing the image forming device 200 to execute printing. Note that, rather than directly instructing the image forming device 200 to perform printing, the print control unit 119 may cause the image forming device 200 to execute printing via another device (for example, a server) that manages or controls printing of the image forming device 200.

Specifically, the print control unit 119 causes the image forming device 200 to print an image acquired by the information processing device 100. When a list in which a plurality of different images in which a designated drawing target is drawn are listed as print candidates is generated by the list output unit 118, the print control unit 119 causes the image forming device 200 to print the list. When the instruction information acquisition unit 111 acquires selection instruction information including an instruction to select a print target out of the plurality of different images listed in the list, the print control unit 119 causes the image forming device 200 to execute printing of an image selected by the selection instruction information among the listed plurality of different images. Accordingly, the user U can freely select an image from the listed images and acquire a print of the image. Therefore, convenience is improved. When the image selected out of the listed plurality of different images is printed, the print control unit 119 acquires the selected image from the storage 300 and causes the image forming device 200 to execute printing of the acquired image. As explained above, the image acquired by the image acquisition unit 115 is stored in the storage 300. Therefore, the image acquisition unit 115 does not need to acquire the selected image again and the processing can be simplified.

The user interface processing unit 120 performs, for example, processing of outputting a response to the instruction information acquired by the instruction information acquisition unit 111 and processing of outputting a status of processing currently performed in the printing system 10. In the present embodiment, since the response and the status explained above are communicated to the user U via the voice system 400, the user interface processing unit 120 transmits text data, which is data of a sentence output by voice from the voice input/output device 410, to the voice processing server 420. In order to transmit the text data, the user interface processing unit 120 may use, as appropriate, according to necessity, the information acquired by the instruction information acquisition unit 111. For example, the user interface processing unit 120 may generate text data by referring to, as appropriate, print instruction information stored in the storage 300 in correlation with an image.

In particular, as specifically exemplified in a sequence chart explained below, the user interface processing unit 120 performs output for urging the user U to input information that should be added as print instruction information. Accordingly, it is possible to acquire a more specific instruction for an image desired by the user.

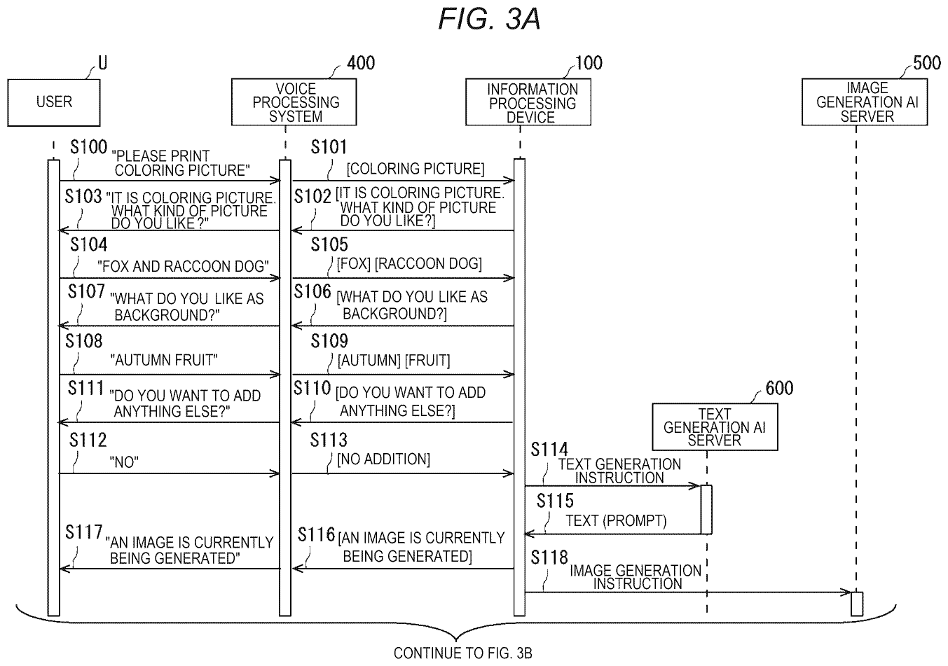

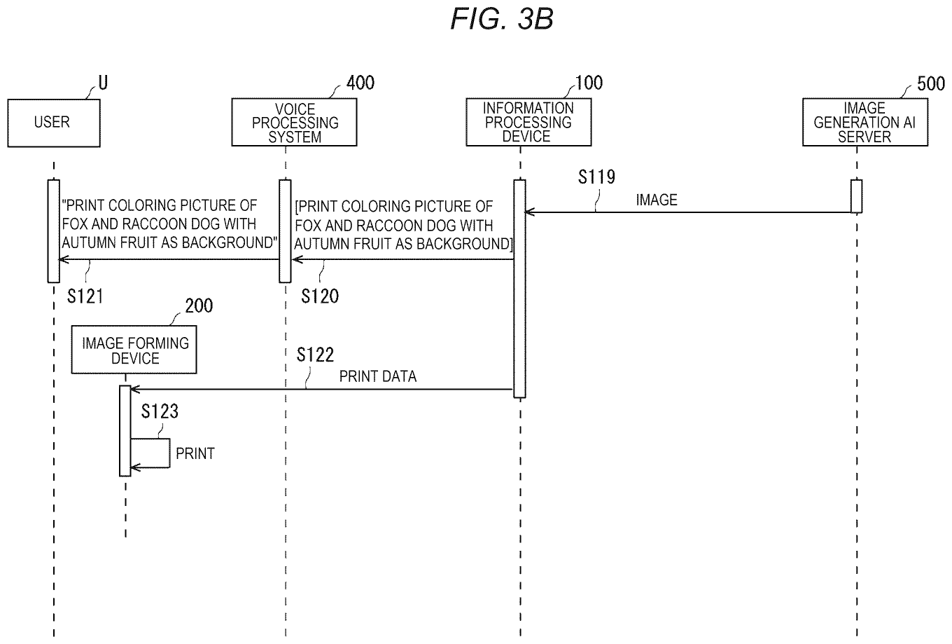

Subsequently, a flow of processing of the printing system 10 is explained using sequence charts. FIG. 3A and FIG. 3B are sequence charts illustrating an example of a flow of processing executed in the printing system 10 according to the embodiment. Here, a case in which the user U desires to print an image of a coloring picture is explained as an example. However, in the printing system 10, various images such as an image of a pattern for design paper and a photographic image can be printed according to desires of the user U. The same applies in other sequence charts explained below. The flow of the processing of the printing system 10 is explained with reference to FIG. 3A and FIG. 3B.

In this example, first, in steps S100 to S113, the information processing device 100 acquires print instruction information via the voice system 400 (the voice input/output device 410 and the voice processing server 420). Specifically, information acquired in steps S101, S105, and S109 explained below corresponds to the print instruction information.

In step S100, the user U utters, for example, “Please print a coloring picture” to the voice input/output device 410. This voice is subjected to voice recognition processing by the voice processing server 420. In step S101, the voice processing server 420 transmits print instruction information for designating a coloring picture as a drawing mode to the information processing device 100. The instruction information acquisition unit 111 of the information processing device 100 acquires the information.

Next, in step S102, as a response to the print instruction information acquired in step S101, the user interface processing unit 120 transmits text data of a sentence “It is a coloring picture. What kind of a picture do you like” to the voice processing server 420. The text data is converted into voice data by the voice processing server 420 and is output as voice from the voice input/output device 410 in step S103.

In step S104, the user U utters, for example, “a fox and a raccoon dog” to the voice input/output device 410. This voice is subjected to voice recognition processing by the voice processing server 420. In step S105, the voice processing server 420 transmits, to the information processing device 100, print instruction information for designating a “fox” and a “raccoon dog” as drawing targets. The instruction information acquisition unit 111 of the information processing device 100 acquires the information.

Subsequently, in step S106, as a response to the print instruction information acquired in step S105, the user interface processing unit 120 transmits text data of a sentence “What do you like as a background?” to the voice processing server 420. The text data is converted into voice data by the voice processing server 420 and is output as voice from the voice input/output device 410 in step S107.

In step S108, the user U utters, for example, “autumn fruit” to the voice input/output device 410. This voice is subjected to voice recognition processing by the voice processing server 420. In step S109, the voice processing server 420 transmits, to the information processing device 100, print instruction information for designating “autumn” and “fruit” as a drawing target for a background. The instruction information acquisition unit 111 of the information processing device 100 acquires the information.

Subsequently, in step S110, as a response to the print instruction information acquired in step S109, the user interface processing unit 120 transmits text data of a sentence “Do you want to add anything else?” to the voice processing server 420. The text data is converted into voice data by the voice processing server 420 and is output as voice from the voice input/output device 410 in step S111.

In step S112, since there is no matter that the user U desires to add about a drawing target or a drawing mode, the user U utters “none” to the voice input/output device 410. This voice is subjected to voice recognition processing by the voice processing server 420. In step S113, the voice processing server 420 transmits, to the information processing device 100, instruction information indicating that there is no item that should be added. The instruction information acquisition unit 111 of the information processing device 100 acquires the information.

Steps S102, S106, and S110 are specific examples of output for urging the user U to input information that should be added as print instruction information. By performing such output, it is possible to acquire a more specific instruction for an image that the user U desires to print.

Subsequently, in step S114, the text request unit 112 of the information processing device 100 generates, based on the print instruction information acquired in the series of steps explained above, a text generation instruction for causing the text generation AI server 600 to generate text. In this example, the text request unit 112 generates a text generation instruction (a prompt) for instructing to generate an image generation instruction (a prompt) for causing the image generation AI server 500 to generate an image in which an autumn fruit is arranged as a background and a fox and a raccoon dog are arranged as a foreground and that is drawn as a coloring picture. Then, the text request unit 112 transmits the generated text generation instruction to the text generation AI server 600.

When receiving the text generation instruction, the text generation AI server 600 generates text of an image generation instruction based on the received text generation instruction and transmits the text to the information processing device 100 in step S115. Then, the text acquisition unit 113 of the information processing device 100 acquires the image generation instruction generated by the text generation AI server 600.

In the example explained here, the image generation instruction is generated using the text generation AI server 600. However, as explained above, the text generation AI server 600 may not always be used to generate the image generation instruction.

In step S116, in order to communicate a current processing status to the user U, the user interface processing unit 120 transmits text data of a sentence, for example, “An image is currently being generated” to the voice processing server 420. The text data is converted into voice data by the voice processing server 420 and is output as voice from the voice input/output device 410 in step S117.

Subsequently, in step S118, the image request unit 114 of the information processing device 100 transmits the image generation instruction acquired in step S115 to the image generation AI server 500. When receiving the image generation instruction, the image generation AI server 500 generates an image based on the received image generation instruction and transmits the generated image to the information processing device 100 in step S119. Accordingly, the image acquisition unit 115 of the information processing device 100 acquires an image in which autumn fruit is arranged as a background and a fox and a raccoon dog are arranged as a foreground and that is drawn as a coloring picture. The storage control unit 117 may store the image acquired by the image acquisition unit 115 in the storage 300. As explained above, the processing unit 116 may perform the image processing on the image acquired in step S119 according to necessity.

Subsequently, in step S120, in order to communicate a current processing status to the user U, the user interface processing unit 120 transmits text data of a sentence, for example, “Print a coloring picture of a fox and a raccoon dog with autumn fruit as a background” to the voice processing server 420. The text data is converted into voice data by the voice processing server 420 and is output as voice from the voice input/output device 410 in step S121.

Subsequently, in step S122, the print control unit 119 performs processing of causing the image forming device 200 to execute printing of the image acquired in step S119 or an image obtained by performing image processing on the image. In the example explained here, the print control unit 119 transmits print data of an image to the image forming device 200 and causes the image forming device 200 to execute printing of the image. As explained above, the print control unit 119 may cause the image forming device 200 to execute printing via another device (for example, a server) that manages or controls printing of the image forming device 200. In this case, the print control unit 119 may transmit the image to the device that manages or controls printing and the device may transmit the print data to the image forming device 200. The same applies to other sequence charts explained below.

Subsequently, in step S123, the image forming device 200 prints the image. Accordingly, the user U can acquire a print of the coloring picture of the fox and the raccoon dog with the autumn fruit as the background.

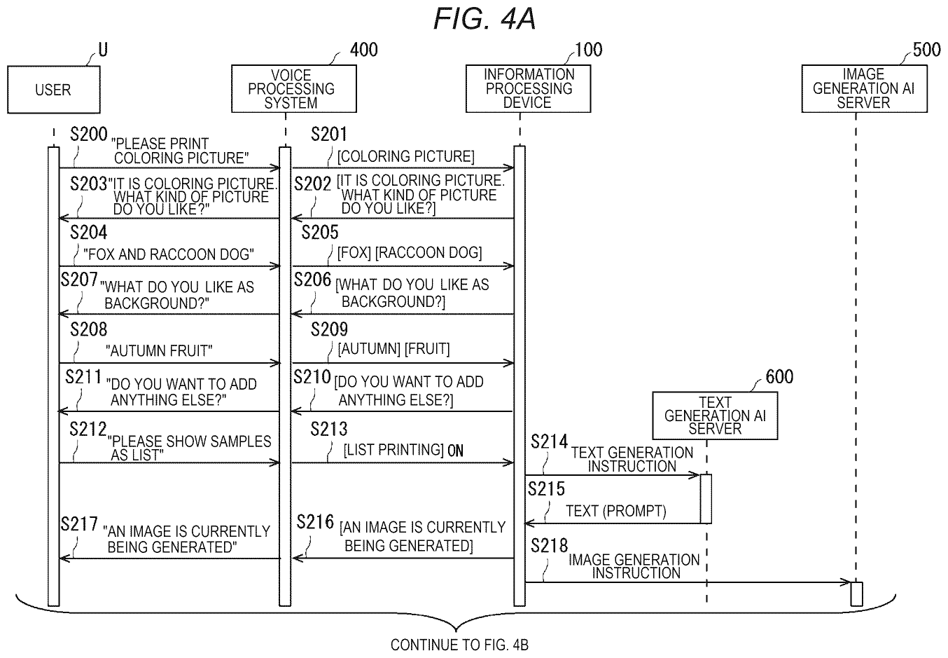

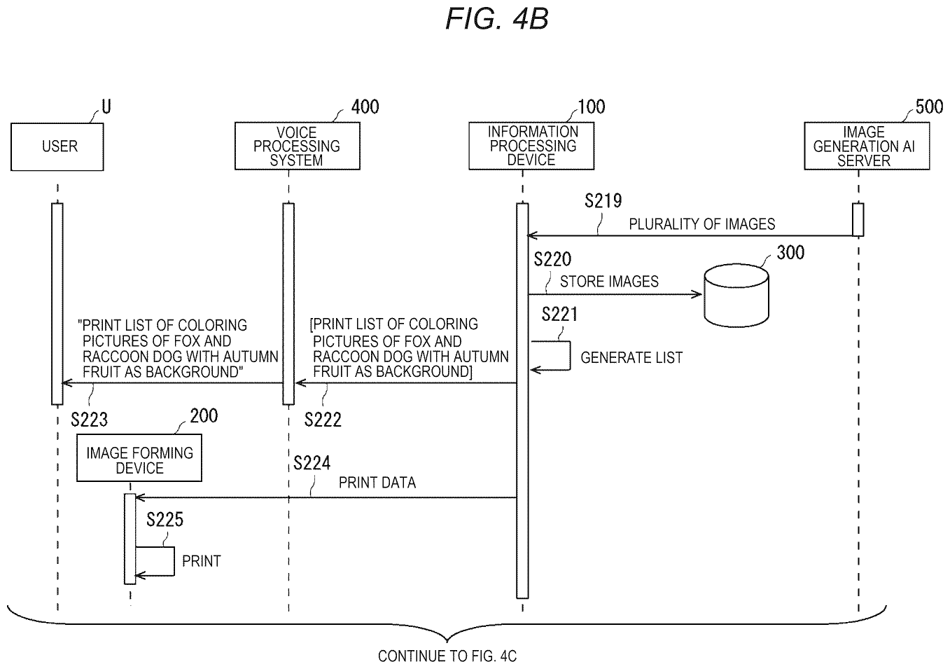

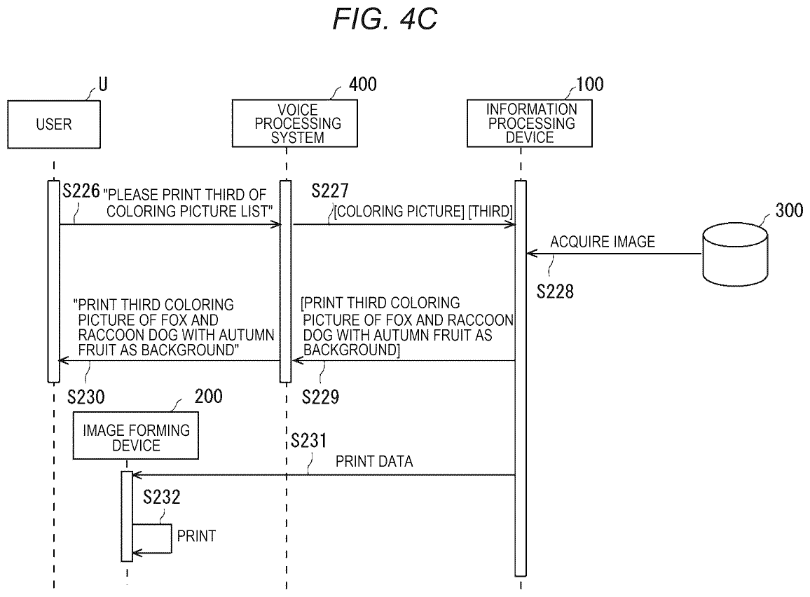

FIG. 4A to FIG. 4C are sequence charts illustrating another example of the flow of the processing performed in the printing system 10 according to the embodiment. In the processing explained with reference to FIG. 3A and FIG. 3B, one image is generated and the generated one image is printed. In contrast, in the processing explained with reference to FIG. 4A to FIG. 4C, a plurality of images are generated and a list in which the images are listed is presented to the user U. Hereinafter, another example of the flow of the processing of the printing system 10 is explained with reference to FIGS. 4A to 4C.

Since processing in step S200 to step S211 in FIG. 4A is the same as the processing in step S100 to step S111 illustrated in FIG. 3A, explanation of the processing is omitted. In the example explained here, after step S211, in step S212, the user U utters, for example, “Please show samples as a list” to the voice input/output device 410 in order to request output of a list. This voice is subjected to voice recognition processing by the voice processing server 420. In step S213, the voice processing server 420 transmits instruction information instructing output of a list to the information processing device 100. The instruction information acquisition unit 111 of the information processing device 100 acquires the information.

Subsequently, in step S214, the text request unit 112 of the information processing device 100 generates, based on the instruction information acquired in the series of steps explained above, a text generation instruction for causing the text generation AI server 600 to generate text. Step S214 is different from step S114 explained above in that a text generation instruction (a prompt) for instructing to generate an image generation instruction (a prompt) for causing the image generation AI server 500 to generate a plurality of images is generated. The text request unit 112 transmits the generated text generation instruction to the text generation AI server 600. The number of images generated when the plurality of images are generated may be, for example, a predetermined number (for example, five) or may be designated by the user U. When the number of images is designated by the user U, instruction information for designating the number of images is acquired by the instruction information acquisition unit 111.

When receiving the text generation instruction, the text generation AI server 600 generates, based on the received text generation instruction, text of an image generation instruction for generating a plurality of images and transmits the text to the information processing device 100 in step S215. Then, the text acquisition unit 113 of the information processing device 100 acquires the image generation instruction generated by the text generation AI server 600.

In the example explained here as well, the image generation instruction is generated using the text generation AI server 600. However, as explained above, the text generation AI server 600 may not always be used to generate the image generation instruction. In the example explained here, when an instruction to output a list is received from the user U as in step S212, acquisition of a plurality of images and output of the list are performed. However, acquisition of a plurality of images and output of the list may be performed irrespectively of presence or absence of such an instruction.

In steps S216 and S217, the same processing as steps S116 and S117 is performed in order to communicate a current processing status to the user U.

Subsequently, in step S218, the image request unit 114 of the information processing device 100 transmits the image generation instruction for generating the plurality of images acquired in step S215 to the image generation AI server 500. When receiving the image generation instruction, the image generation AI server 500 generates a plurality of images based on the received image generation instruction and transmits the generated plurality of images to the information processing device 100 in step S219. Here, as an example, it is assumed that five images are generated and these images are transmitted to the information processing device 100.

In step S220, the storage control unit 117 stores the images acquired in step S219 in the storage 300. In step S221, the list output unit 118 generates a list in which the plurality of images acquired in step S219 are listed as print candidates.

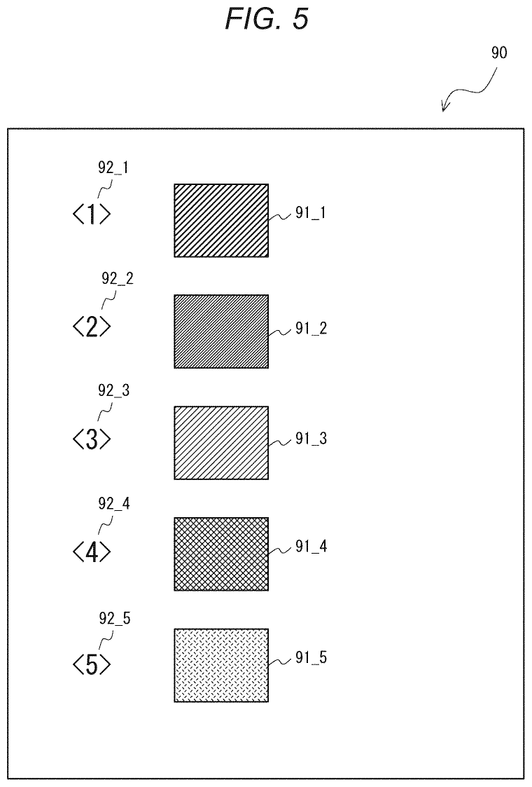

FIG. 5 is a schematic diagram illustrating an example of a list generated by the list output unit 118. In the example illustrated in FIG. 5, in a list 90, thumbnail images 91_1 to 91_5 of the five different images acquired in step S219 are described. Numbers 92_1 to 92_5 are added to the thumbnail images as identifiers for identifying the images. In order to store a correspondence relationship between the identifiers and the images, the storage control unit 117 preferably stores the identifiers of the images shown in the list in the storage 300 in correlation with the images corresponding to the identifiers.

Subsequently, in step S222, in order to communicate a current processing status to the user U, the user interface processing unit 120 transmits text data of a sentence, for example, “Print a list of coloring pictures of a fox and a raccoon dog with autumn fruit as a background” to the voice processing server 420. The text data is converted into voice data by the voice processing server 420 and is output as voice from the voice input/output device 410 in step S223.

In step S224, the list output unit 118 requests the print control unit 119 to perform print processing for the generated list. In response to the request, the print control unit 119 performs processing of causing the image forming device 200 to print the list generated in step S221. Accordingly, in step S225, the image forming device 200 prints a list in which a plurality of images are listed as print candidates.

The user U having checked the list selects an image that the user U desires to print among the listed images. Then, in step S226, the user U utters, for example, “Please print the third of the coloring picture list” to the voice input/output device 410. This voice is subjected to voice recognition processing by the voice processing server 420. In step S227, the voice processing server 420 transmits, to the information processing device 100, selection instruction information for selecting an image of a third coloring picture in the list as a print target. The instruction information acquisition unit 111 of the information processing device 100 acquires the information.

Subsequently, in step S228, the print control unit 119 acquires the image selected by the selection instruction information from the storage 300. In step S229, in order to communicate a current processing status to the user U, the user interface processing unit 120 transmits text data of a sentence, for example, “Print a third coloring picture of a fox and a raccoon dog with autumn fruit as a background” to the voice processing server 420. The text data is converted into voice data by the voice processing server 420 and is output as voice from the voice input/output device 410 in step S230.

In step S231, the print control unit 119 performs processing of causing the image forming device 200 to execute printing of the image acquired from the storage 300 in step S228. Subsequently, in step S232, the image forming device 200 prints the image. Accordingly, the user U can acquire a print of an image selected from the list.

Several modifications of the embodiment explained above are explained below.

### Modification 1

First, a modification 1 is explained. The modification 1 is different from the embodiment explained above in that the list explained above includes code images indicating access destinations for acquiring images listed in the list from the storage 300. In the following explanation, characteristics, or operations different from those in the embodiment explained above are explained and explanation of the same characteristics or operations is omitted as appropriate.

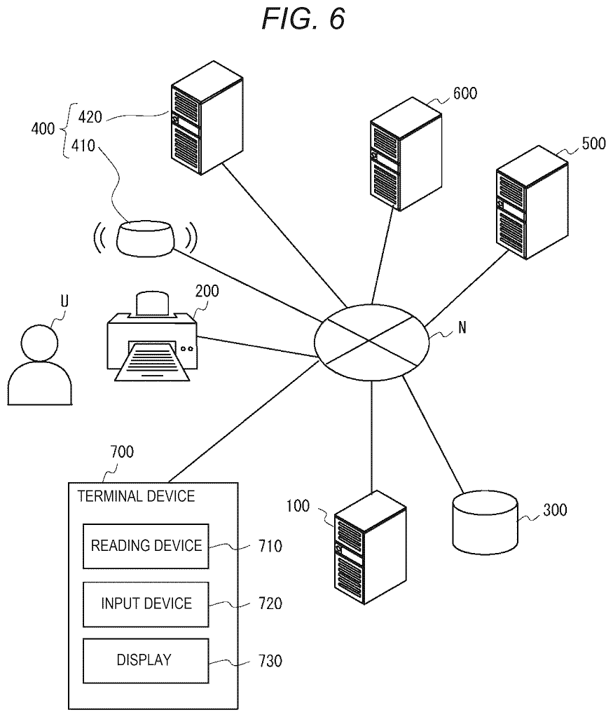

FIG. 6 is a block diagram illustrating an example of a configuration of a printing system 10a according to the modification 1. The configuration of the printing system 10a illustrated in FIG. 6 is different from the configuration of the printing system 10 illustrated in FIG. 1 in that the printing system 10a includes a terminal device 700 for reading a code image included in a list. The terminal device 700 is also connected to the network N.

The terminal device 700 is a device operated by a user U and is, for example, a smartphone, a tablet terminal, or a personal computer. The terminal device 700 includes a reading device 710 such as a camera for reading a code image, an input device 720 such as a button or a pointing device for receiving input operation from the user U, and a display 730. The terminal device 700 may include a touch panel in which the input device 720 and the display 730 are integrally configured. Application software (hereinafter referred to as print application) for causing the image forming device 200 to print an image according to an instruction of the user U via the input device 720 is preferably installed in the terminal device 700. When the terminal device 700 and the image forming device 200 communicate with each other, the network N may not always be used. The terminal device 700 and the image forming device 200 may directly communicate with each other.

In the present modification, the list output unit 118 of the information processing device 100 lists a plurality of different images as print candidates and generates a list including code images for acquiring images stored in the storage 300 from the storage 300. Here, the code image is, for example, a two-dimensional code image such as a QR code (registered trademark) but may be a one-dimensional code image such as a barcode. The code image is an image obtained by encoding information indicating an access destination for acquiring an image listed in the list from the storage 300. More specifically, the code image is an image obtained by encoding information (for example, a Uniform Resource Identifier (URI)) indicating a storage position of data of an image stored in the storage 300. As explained above, in the present modification, the list including the code images is output.

The terminal device 700 reads the code images of the output list with the reading device 710 and accesses the images stored in the storage 300. For example, the user U reads, with the reading device 710, a code image of an image that the user U desires to print. Accordingly, it is possible to display the image on the display 730 of the terminal device 700 it is also possible to cause the image forming device 200 to print the image via a print application.

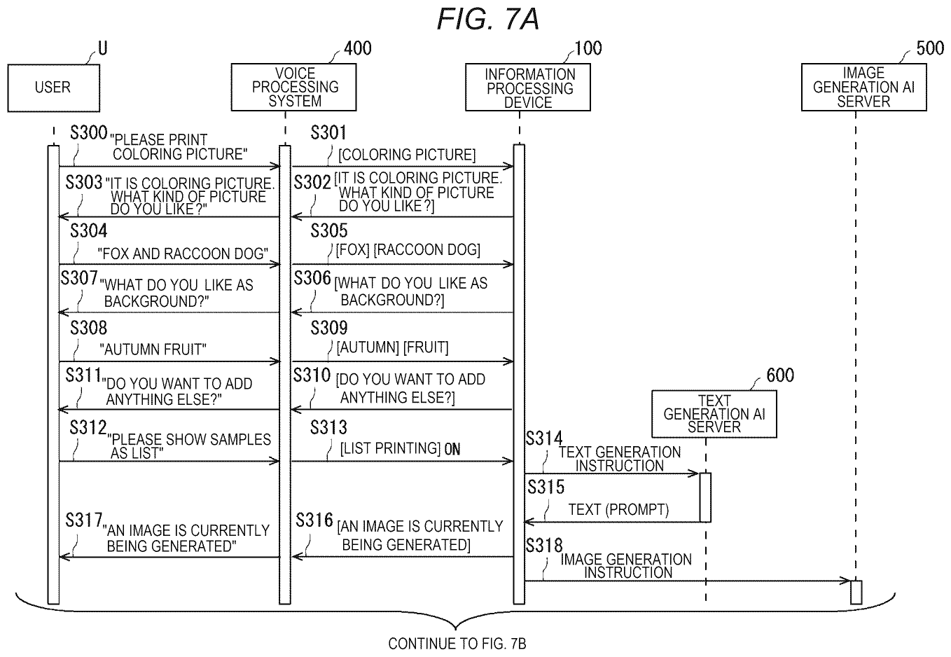

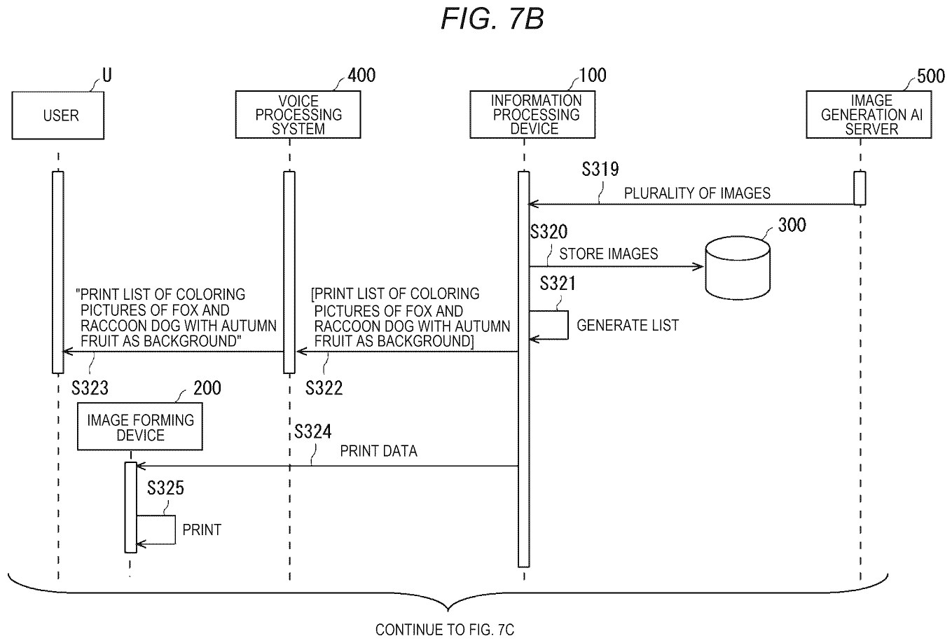

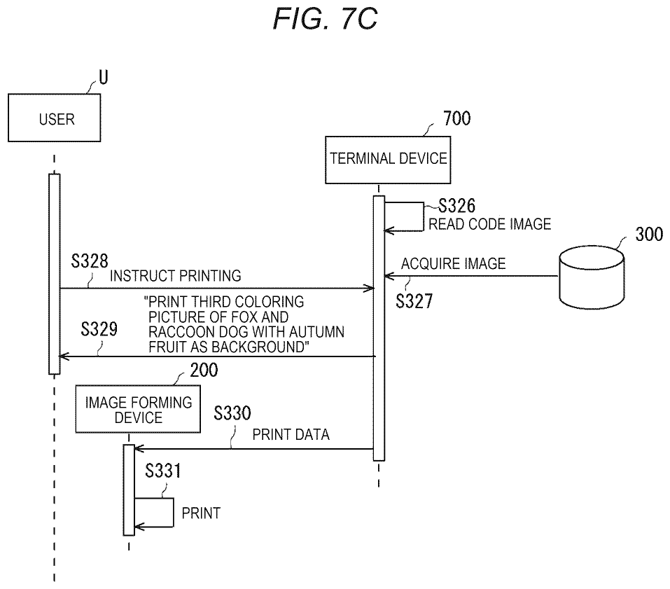

FIGS. 7A to 7C are sequence charts illustrating an example of a flow of processing executed in the printing system 10a according to the modification 1. In the following explanation, a flow of processing of the printing system 10a according to the modification 1 is explained with reference to FIGS. 7A to 7C.

Processing in step S300 to step S318 in FIG. 7A is the same as the processing in step S200 to step S218 illustrated in FIG. 4A. Processing in step S319 to step S320 in FIG. 7B is the same as the processing in step S219 to step S220 in FIG. 4B. Therefore, explanation of the steps is omitted.

In the modification 1, after step S320, in step S321, the list output unit 118 of the information processing device 100 generates a list in which the plurality of images acquired in step S319 are listed as print candidates. In particular, the list output unit 118 generates a list including for acquiring images stored in the storage 300 from the storage 300.

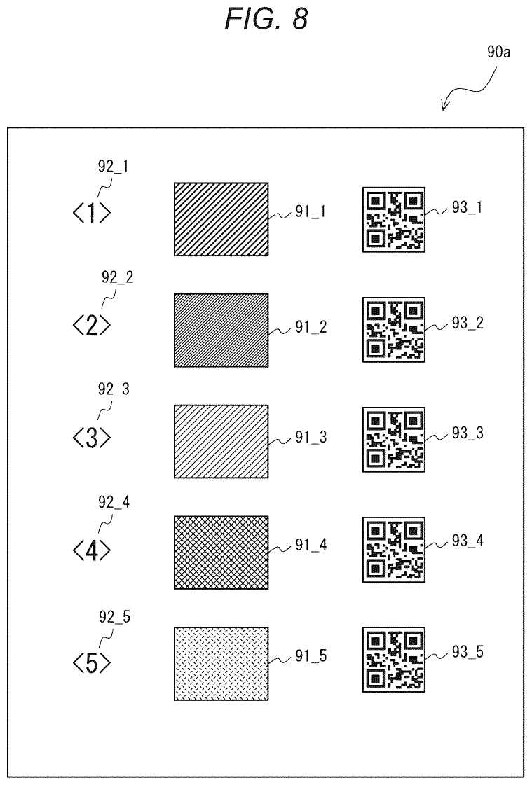

FIG. 8 is a schematic diagram illustrating an example of a list generated by the list output unit 118 in the modification 1. In the example illustrated in FIG. 8, in a list 90a, thumbnail images 91_1 to 91_5 of the five different images acquired in step S319 are described. Numbers 92_1 to 92_5 are added to the thumbnail images as identifiers for identifying the images. Further, in the list 90a, code images 93_1 to 93_5 indicating access destinations for acquiring the images corresponding to the thumbnail images from the storage 300 are described.

Subsequently, in steps S322 and S323, the same processing as the processing in steps S222 and S223 is performed in order to communicate a current processing status to the user U.

In step S324, the list output unit 118 requests the print control unit 119 to perform print processing for the list including the code images. In response to the request, the print control unit 119 performs processing of causing the image forming device 200 to execute printing the list including the code images generated in step S321. Accordingly, in step S325, the image forming device 200 prints a list in which a plurality of images are listed as print candidates and that indicates access destinations of the images.

Subsequently, in step S326, the user U having checked the list reads, with the terminal device 700, a code image of an image that the user U desires to print among the listed images. Here, as an example, the reading is performed via a print application.

Subsequently, in step S327, the terminal device 700 acquires, based on the read code image, an image stored in the storage 300. Acquisition processing for the image is executed by, for example, a print application. In the example explained here, it is assumed that a code image corresponding to a third image of the list is read and the third image of the list is acquired by the processing in steps S326 and S327.

Subsequently, in step S328, the user U operates the input device 720 of the terminal device 700 to instruct the print application to print an image corresponding to the read code image.

Subsequently, in step S329, in order to communicate a current processing status to the user U, the print application displays a message, for example, “Print a third coloring picture of a fox and a raccoon dog with autumn fruit as a background” on the display 730 of the terminal device 700.

In step S330, the print application of the terminal device 700 performs processing of causing the image forming device 200 to print the image acquired from the storage 300 in step S327. In the example explained here, the print application transmits print data of an image to the image forming device 200 and causes the image forming device 200 to execute printing of the image. The print application may cause the image forming device 200 to execute printing via the information processing device 100 or via another device that manages or controls printing of the image forming device 200.

Subsequently, in step S331, the image forming device 200 prints an image. Accordingly, the user U can acquire a print of an image corresponding to a read code image.

In the present modification, the list output by the information processing device 100 includes code images indicating access destinations for acquiring listed images from the storage 300. For this reason, the terminal device 700 is capable of easily accessing an image stored in the storage 300 and the image can be easily used in the terminal device 700.

### Modification 2

Subsequently, a modification 2 is explained. In some case, it takes a lot of time for processing of the information processing device 100 acquiring an image matching a desire of a user, in particular, acquiring an image from the image generation AI server 500. For this reason, the user U is kept waiting for a long time until the image is printed. Thus, the present modification is different from the embodiment explained above in that processing of acquiring an image from another device such as the image generation AI server 500 is limited in the information processing device 100. In the following explanation, characteristics or operations different from those in the embodiment or the modification explained above are explained and explanation of the same characteristics or operations is omitted as appropriate.

In the present modification, when the image corresponding to the print instruction information acquired by the instruction information acquisition unit 111 is not stored in the storage 300, the image request unit 114 requests, using the print instruction information, the image generation AI server 500 to transmit an image in which the designated drawing target is drawn. That is, only when the image corresponding to the print instruction information acquired by the instruction information acquisition unit 111 is not stored in the storage 300, the image request unit 114 transmits an image generation instruction generated based on the print instruction information to the image generation AI server 500. For this reason, cases of using the image generation AI server 500 are limited and the number of times the user U is kept waiting for a long time can be reduced.

More specifically, in the present modification, the storage control unit 117 and the image request unit 114 operate as explained below. Here, print instruction information acquired by the instruction information acquisition unit 111 at a first point in time is referred to as first print instruction information and print instruction information acquired by the instruction information acquisition unit 111 at a second point in time is referred to as second print instruction information. It is assumed that an image corresponding to the first print instruction information is not stored in the storage 300 at the first point in time.

In the present modification, the image request unit 114 requests the image generation AI server 500 to transmit an image in which a drawing target designated by the first print instruction information is drawn. The image acquisition unit 115 acquires the image from the image generation AI server 500. At this time, the storage control unit 117 causes the storage 300 to store the acquired image in correlation with tag information obtained from the first print instruction information used to acquire the image. Specifically, the tag information obtained from the print instruction information may be information indicating a drawing target designated by the print instruction information or may be information indicating a drawing mode designated by the print instruction information. The tag information stored in the storage 300 in correlation with the image is used to retrieve the image from the storage 300.

When the instruction information acquisition unit 111 acquires the second print instruction information at the second point in time after the first point in time, when an image stored in correlation with the tag information corresponding to the second print instruction information is not stored in the storage 300, the image request unit 114 requests the image generation AI server 500 to transmit the image using the second print instruction information. In this case, the print control unit 119 causes the image forming device 200 to execute printing of an image acquired anew from the image generation AI server 500 by the image acquisition unit 115.

In contrast, when the image stored in correlation with the tag information corresponding to the second print instruction information is present in the storage 300, a transmission request for the image to the image generation AI server 500 by the image request unit 114 is not performed. The print control unit 119 acquires the image from the storage 300 and causes the image forming device 200 to print the acquired image.

Here, the tag information corresponding to the second print instruction information is tag information coinciding with or tag information similar to the tag information obtained from the second print instruction information. That is, when the second print instruction information is acquired, an image from the image generation AI server 500 is acquired only when an image stored in correlation with the tag information coinciding with or the tag information similar to the tag information obtained from the second print instruction information is absent in the storage 300. For example, the image acquisition unit 115 finds, from the storage 300, an image correlated with tag information indicating a drawing target coinciding with or similar to a drawing target designated by the second print instruction information and also correlated with tag information indicating a drawing mode coinciding with or similar to a drawing mode designated by the second print instruction information. Only when such an image is absent, the image acquisition unit 115 acquires an image generated by the image generation AI server 500. Note that whether the image corresponding to the second print instruction information is stored in the storage 300 may be checked by focusing on only one of the drawing target and the drawing mode.

Information other than the tag information explained above may be stored in the storage 300 in correlation with the image acquired from the image generation AI server 500. For example, identification information of the user U who has given the instruction indicated by the first print instruction information may be correlated with the image. That is, the storage control unit 117 may cause the storage 300 to store the image acquired from the image generation AI server 500 in correlation with tag information obtained from the first print instruction information used to acquire the image and identification information of the user U included in the first print instruction information. When the image stored in correlation with the identification information of the user U included in the second print instruction information and the tag information corresponding to the second print instruction information is absent in the storage 300, the image request unit 114 requests, using the second print instruction information, the image generation AI server 500 to transmit the image. In this case, the print control unit 119 causes the image forming device 200 to execute printing of an image acquired anew from the image generation AI server 500 by the image acquisition unit 115. In contrast, when the image stored in correlation with the identification information of the user U included in the second print instruction information and the tag information corresponding to the second print instruction information is present in the storage, the print control unit 119 causes the image forming device 200 to execute printing of the image acquired from the storage 300. With such a configuration, an image can be reused for each user. When print instruction information concerning a certain user is acquired and an image of the user is absent in the storage 300, an image of another user may be acquired. That is, when an image correlated with the tag information corresponding to the second print instruction information but correlated with user identification information different from the identification information of the user U included in the second print instruction information is present in the storage 300, the image acquisition unit 115 may acquire the image. With such a configuration, reuse of an image can be promoted.

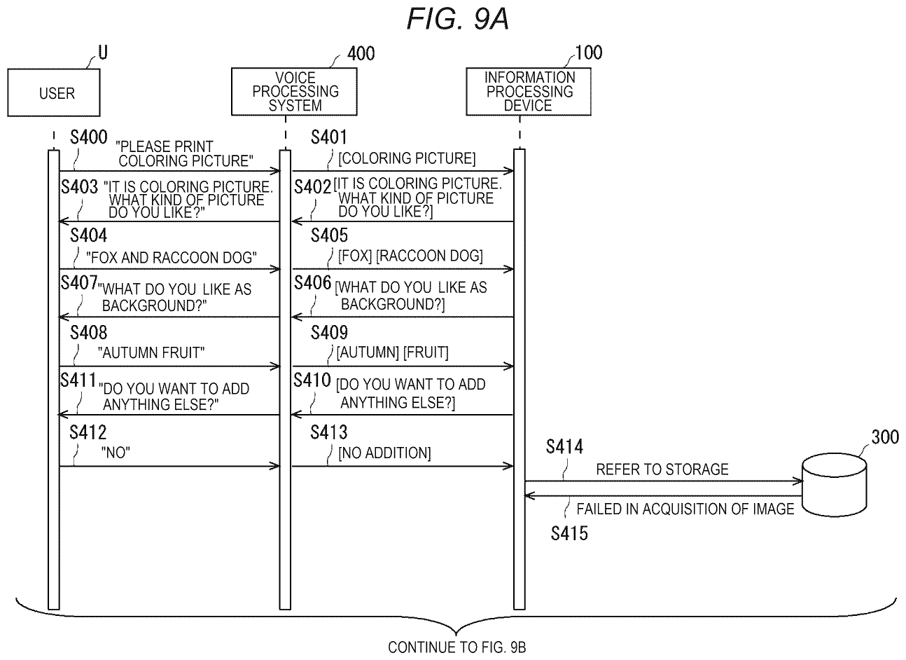

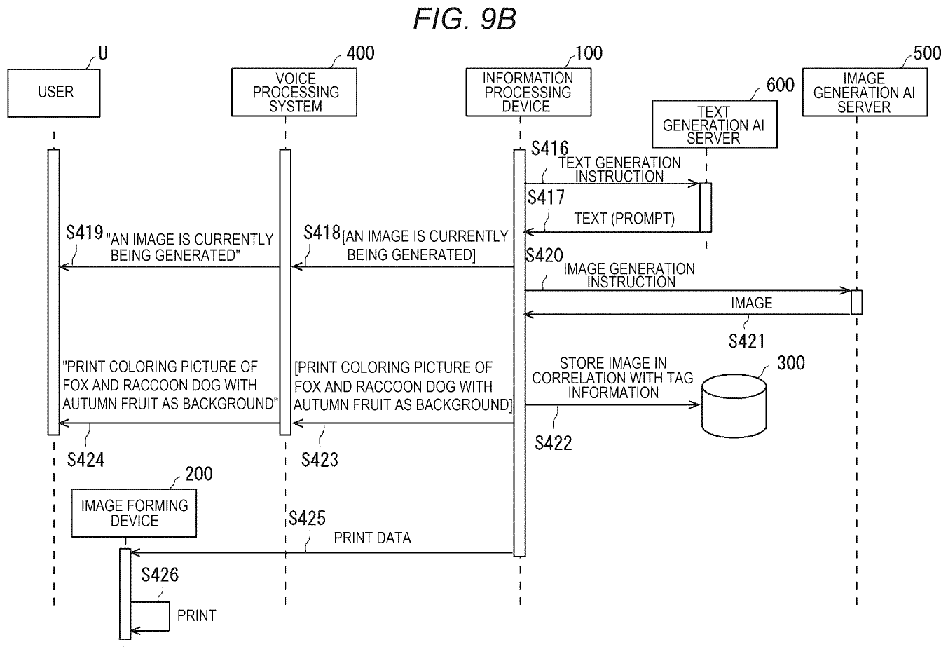

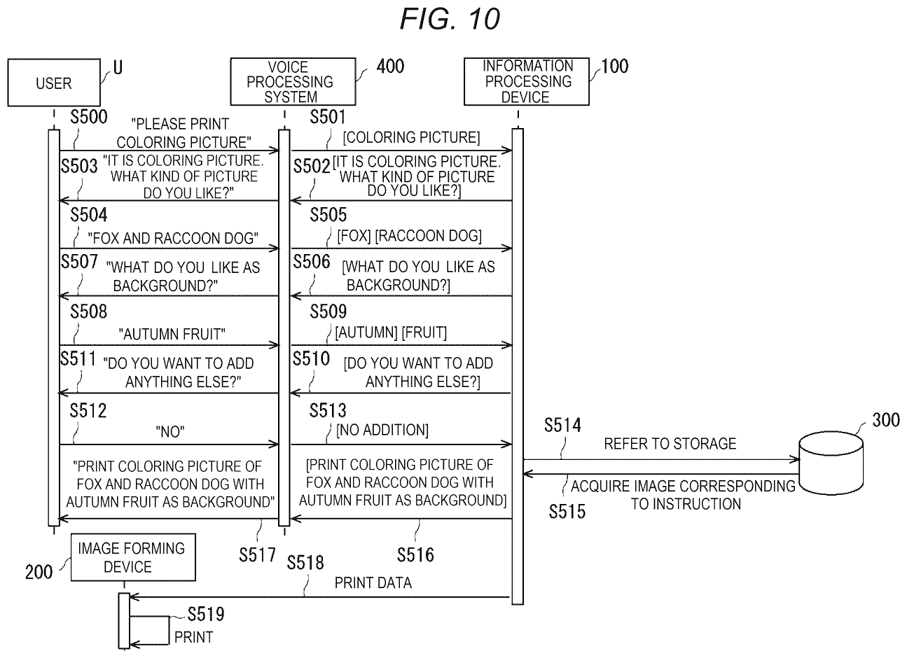

FIGS. 9A and 9B and FIG. 10 are sequence charts illustrating an example of a flow of processing executed in the printing system 10 according to the modification 2. In particular, FIGS. 9A to 9B are sequence charts illustrating an example of processing of the printing system 10 at the first point in time when the first instruction information is acquired. FIG. 10 is a sequence chart illustrating an example of processing of the printing system 10 at the second point in time when the second instruction information is acquired. It is assumed that an image corresponding to the first print instruction information is not stored in the storage 300 at the first point in time. First, the flow of the processing of the printing system 10 according to the modification 2 at the first point in time is explained with reference to FIGS. 9A and 9B.

The processing in step S400 to step S413 in FIG. 9A is the same as the processing in step S100 to step S113 illustrated in FIG. 3A. That is, in steps S400 to S413, the information processing device 100 acquires the first print instruction information. Specifically, information acquired in steps S401, S405, and S409 is equivalent to the first print instruction information.

In the modification 2, after step S413, in step S414, the image acquisition unit 115 refers to the storage 300 and checks whether an image corresponding to an instruction of the user U is stored in the storage 300. That is, the image acquisition unit 115 checks whether the image stored in correlation with the tag information corresponding to the first print instruction information is present in the storage 300. Here, since such an image is not stored in the storage 300, the image acquisition unit 115 fails in acquiring the image from the storage 300 in step S415. For this reason, in the next step S416 to step S421, processing of acquiring an image from the image generation AI server 500 is performed. Since the processing in step S416 to step S421 is the same as the processing in step S114 to step S119 illustrated in FIGS. 3A and 3B, explanation of the processing is omitted.

After step S421, in step S422, the storage control unit 117 causes the storage 300 to store the image acquired from the image generation AI server 500 in step S421 in correlation with the tag information obtained from the first print instruction information. As explained above, the storage control unit 117 may cause the storage 300 to store the identification information of the user U in correlation with the image.

Thereafter, in steps S423 to S426, processing of printing the image acquired from the image generation AI server 500 with the image forming device 200 is performed. Since the processing in step S423 to step S426 is the same as the processing in step S120 to step S123 illustrated in FIG. 3B, explanation of the processing is omitted.

Subsequently, a flow of processing of the printing system 10 according to the modification 2 at the second point in time is explained with reference to FIG. 10.

The processing in step S500 to step S513 in FIG. 10 is the same as the processing in step S100 to step S113 illustrated in FIG. 3A. That is, in steps S500 to S513, the information processing device 100 acquires the second print instruction information. Specifically, information acquired in steps S501, S505, and S509 is equivalent to the second print instruction information.

After step S513, in step S514, the image acquisition unit 115 refers to the storage 300 and checks whether an image corresponding to an instruction of the user U is stored in the storage 300. That is, the image acquisition unit 115 checks whether the image stored in correlation with the tag information corresponding to the second print instruction information is present in the storage 300. As explained above, it may be checked whether an image stored in correlation with the same identification information as the identification information of the user U who has given an instruction at the second point in time and in correlation with the tag information corresponding to the second print instruction information is stored in the storage 300. Here, since such an image has already been stored in the storage 300 in step S422 explained above, the image acquisition unit 115 acquires an image corresponding to the second print instruction information from the storage 300 in step S515. For this reason, execution of processing of acquiring an image from the image generation AI server 500 is omitted. Therefore, generation processing for an image by the image generation AI server 500 is also omitted.

Thereafter, in steps S516 to S519, processing of printing the image acquired from the storage 300 with the image forming device 200 is performed. Since the processing in step S516 to step S519 is the same as the processing in step S120 to step S123 illustrated in FIG. 3B, explanation of the processing is omitted.

In the example explained above, a list in which a plurality of images are listed is not output. However, in the present modification as well, acquisition of a plurality of images may be performed and output of a list in which the plurality of images are listed may be performed. That is, when the first print instruction information is acquired, the storage control unit 117 may cause the storage 300 to store each of the plurality of images acquired from the image generation AI server 500 in correlation with the tag information obtained from the first print instruction information. Then, the list output unit 118 may generate a list in which the plurality of images acquired from the image generation AI server 500 are listed and perform output processing for the list. Similarly, when the second print instruction information is acquired, when a plurality of images are successfully acquired from the storage 300 as images corresponding to the second print instruction information, the list output unit 118 may generate a list in which the plurality of images acquired from the storage 300 are listed and perform output processing of the list. The number of times an image stored in the storage 300 is printed may be stored in correlation with the image. In that case, the list output unit 118 may output a list in which the number of times of printing of each of the listed images is described. The list output unit 118 may output a list in which the listed images are sorted according to the number of times of printing. Specifically, a list in which an image having a larger number of times of printing is listed higher may be output. Accordingly, it is possible to provide information useful for the user U to select an image. In the present modification as well, the list to be output may include code images for accessing the listed images. When the list is output, the print control unit 119 causes the image forming device 200 to execute printing of an image selected by the user U among the listed plurality of images.

When acquisition of a new image rather than an existing image stored in the storage 300 is requested from the user U, acquisition of an image from the image generation AI server 500 may be executed regardless of whether an image corresponding to the print instruction information is stored in the storage 300. That is, when the acquired print instruction information includes an instruction to print a new image, the image request unit 114 may request the image generation AI server 500 to transmit an image corresponding to the print instruction information using the print instruction information regardless of whether the image is stored in the storage 300. Accordingly, the user U can freely select whether to allow diverted use of the existing image.

The modification 2 is explained above. In the present modification, as explained above, only when the image corresponding to the print instruction information acquired by the instruction information acquisition unit 111 is not stored in the storage 300, the image request unit 114 transmits the image generation instruction generated based on the print instruction information to the image generation AI server 500. For this reason, cases of using the image generation AI server 500 are limited and the number of times the user U is kept waiting for a long time can be reduced. Since the number of times the image generated by the image generation AI server 500 is stored in the storage 300 can be reduced, it is possible to prevent a free space of the storage 300 from decreasing. In particular, in the generation of an image using the image generation AI server 500 (that is, the image generation AI service), even when generation of an image is instructed by the same image generation instruction, a different image is sometimes generated every time the image is generated. For this reason, the user U sometimes cannot print again an image printed in the past. In contrast, in the present modification, there is also an advantage that an image printed in the past can be acquired from the storage 300 and repeatedly printed.

### Modification 3

Subsequently, a modification 3 is explained. The present modification is different from the embodiment or the modifications explained above in that a favorite image of a user can be registered in the printing system and, thereafter, the registered image can be printed. In the following explanation, characteristics or operations different from those in the embodiment or the modification explained above are explained and explanation of the same characteristics or operations is omitted as appropriate.

In the present modification, the instruction information acquisition unit 111 can acquire registration instruction information that is instruction information including an instruction to register an image as a favorite image. For example, the user U performs, on the printing system 10, voice input for instructing to register, as a favorite image, an image that the user U likes among images printed using the printing system 10. Information input to the printing system 10 in this way is acquired by the instruction information acquisition unit 111 as registration instruction information. In the present modification, the instruction information acquisition unit 111 can acquire print instruction information for instructing printing of the registered favorite image.

In the present modification, when the instruction information acquisition unit 111 acquires registration instruction information, the storage control unit 117 causes the storage 300 to store, as a favorite image, an image instructed to be registered as a favorite image in the registration instruction information. Specifically, the storage control unit 117 causes the storage 300 to store tag information indicating a favorite image and an image that should be stored as a favorite image in correlation with each other.

In the present modification, when the instruction information acquired by the instruction information acquisition unit 111 is print instruction information for instructing printing of a favorite image, the image acquisition unit 115 acquires the image stored as the favorite image from the storage 300. That is, the image acquisition unit 115 acquires the image stored in correlation with the tag information indicating the favorite image. Then, the print control unit 119 causes the image forming device 200 to print the image acquired from the storage 300. Accordingly, the user U can repeatedly print the favorite image. In particular, in the generation of an image using the image generation AI server 500 (that is, the image generation AI service), even when the generation of an image is instructed by the same image generation instruction, a different image is sometimes generated every time the image is generated. For this reason, the user U sometimes cannot print again the favorite image. In contrast, in the present modification, there is an advantage that the image registered as the favorite image can be acquired from the storage 300 and repeatedly printed.

Note that, in order to more reliably specify a favorite image that the user U desires to print, the print instruction information for instructing printing of a favorite image preferably includes information for specifying an image registered as a favorite image (hereinafter also referred to as favorite specifying information). In this case, the image acquisition unit 115 acquires, from the storage 300, an image specified by the favorite specifying information among images stored in the storage 300 as favorite images. The print control unit 119 causes the image forming device 200 to print the acquired image. With such a configuration, it is possible to more reliably acquire, from the storage 300, a favorite image that the user U desires to print and print the favorite image.

The favorite specifying information may be information indicating a drawing target of an image registered as a favorite image or may be information indicating a drawing mode of an image registered as a favorite image. For this reason, in the present modification as well, as in the modification 2, the image stored in the storage 300 may be correlated with the tag information obtained from the print instruction information.

Further, the favorite specifying information may be information indicating a point in time when a specifying target image was registered as a favorite image. In this case, when registration of the favorite image is performed, the storage control unit 117 causes the storage 300 to store the image registered as the favorite image in correlation with the information indicating the registration point in time of the image. Since the information indicating the registration point in time is used as the favorite specifying information, the user U can specify the image with the registration point in time. Therefore, convenience is improved.

The favorite specifying information is not limited to the information explained above. For example, the favorite specifying information may be identification information of a user who has given an instruction to register a specifying target image as a favorite image. In this case, when registration of a favorite image is performed, the storage control unit 117 only has to cause the storage 300 to store an image registered as the favorite image in correlation with identification information of the user U included in registration instruction information, that is, identification information of the user U who gave an instruction indicated by the registration instruction information. Accordingly, it is possible to specify a favorite image using identification information of a user. The various kinds of favorite specifying information explained above may be used in combination.

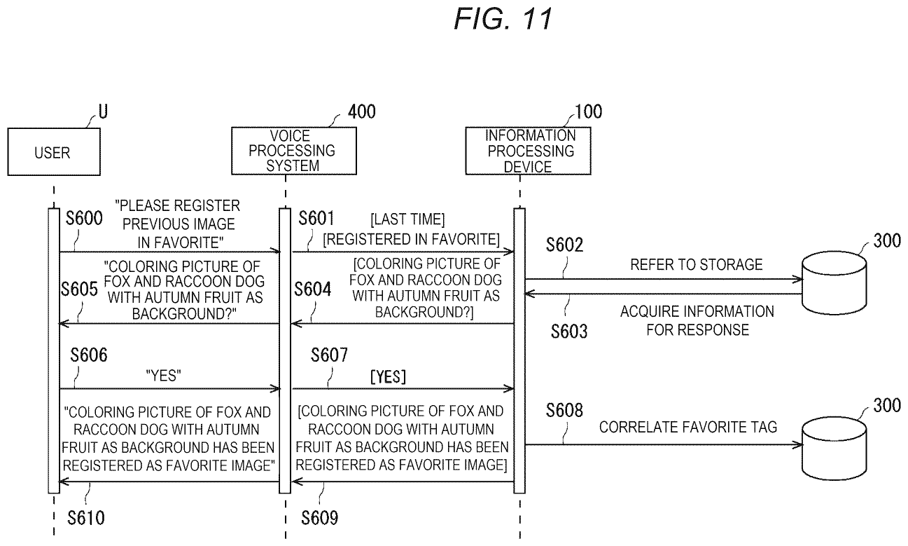

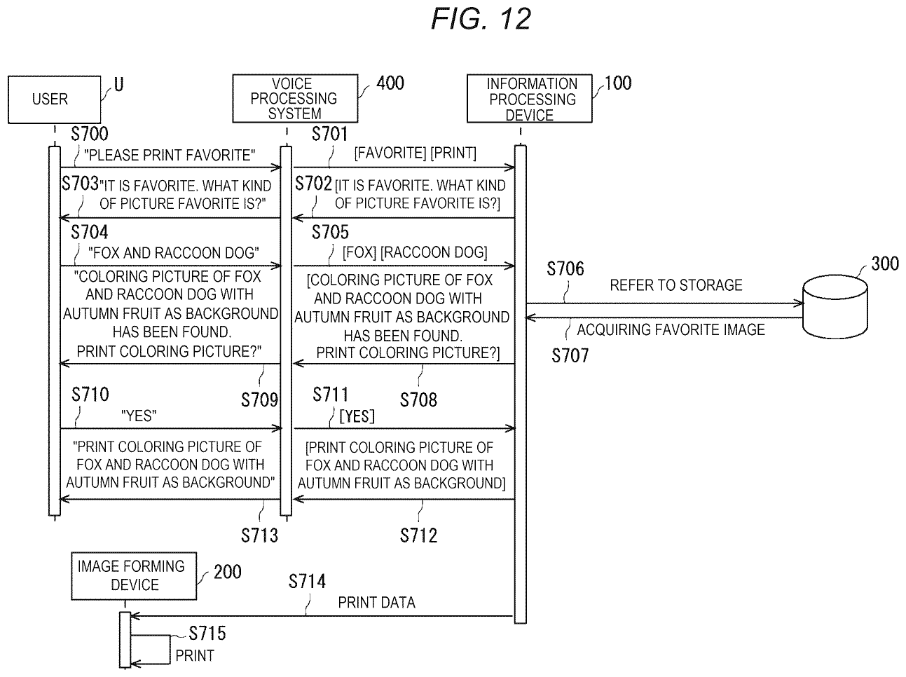

FIGS. 11 and 12 are sequence charts illustrating an example of a flow of processing executed in the printing system 10 according to the modification 3. FIG. 11 is a sequence chart illustrating an example of a flow of processing at the time when registration of a favorite image is performed. More specifically, FIG. 11 illustrates an example of a flow of processing performed after printing based on print instruction information is performed in the printing system 10. Therefore, it is assumed that, for example, a series of processing illustrated in FIGS. 9A and 9B is performed before a sequence illustrated in FIG. 11. However, in the present modification, the processing in steps S414 and S415 in FIG. 9A relating to the characteristics of the modification 2 may be omitted. FIG. 12 is a sequence chart illustrating an example of a flow of processing at the time when printing of a favorite image is performed.

First, the example of the flow of the processing at the time when registration of a favorite image is performed is explained with reference to FIG. 11.

As illustrated in FIG. 11, the instruction information acquisition unit 111 of the information processing device 100 acquires registration instruction information via the voice system 400 (the voice input/output device 410 and the voice processing server 420). Specifically, information acquired in steps S601 and S607 explained below is equivalent to the registration instruction information.

In step S600, the user U utters, for example, “Please register the previous image in a favorite” to the voice input/output device 410. This voice is subjected to voice recognition processing by the voice processing server 420. In step S601, the voice processing server 420 transmits, to the information processing device 100, registration instruction information for instructing to register a print target image in the last print processing as a favorite image. The instruction information acquisition unit 111 of the information processing device 100 acquires the information.

Subsequently, in step S602, the storage control unit 117 refers to the storage 300 and finds, based on the registration instruction information acquired in step S601, from the storage 300, a candidate of an image to be registered as a favorite image. Then, in step S603, in order to output a response to the user U, the storage control unit 117 acquires information stored in correlation with the candidate of the image to be registered as a favorite image. Specifically, the storage control unit 117 acquires information representing contents of the image such as a drawing target and a drawing mode.

Subsequently, in step S604, the user interface processing unit 120 outputs a response to the registration instruction information acquired in step S601 based on the information acquired in step S603. For example, the user interface processing unit 120 transmits, to the voice processing server 420, text data of a sentence “A coloring picture of a fox and a raccoon dog with autumn fruit as a background?”. The text data is converted into voice data by the voice processing server 420 and is output as voice from the voice input/output device 410 in step S605.

In step S606, the user U utters, for example, “Yes” to the voice input/output device 410. This voice is subjected to voice recognition processing by the voice processing server 420. In step S607, the voice processing server 420 transmits, to the information processing device 100, information indicating that the image to be registered as a favorite image is not the image found in step S602. The instruction information acquisition unit 111 of the information processing device 100 acquires the information.

Subsequently, in step S608, the storage control unit 117 causes the storage 300 to store the image found in step S602 as a favorite image. Specifically, the storage control unit 117 causes the storage 300 to store, in correlation with each other, the image and tag information indicating that the image is a favorite image. Accordingly, for example, tag information indicating a favorite image is added anew to the image to which the tag information based on the print instruction information is already associated in step S422 of FIG. 9B. In step S608, as explained above, the storage control unit 117 may cause the storage 300 to store the information indicating the registration point in time as the favorite image and the identification information of the user U in correlation with the favorite image.

Subsequently, in step S609, as a response to the information acquired in step S607, the user interface processing unit 120 transmits, to the voice processing server 420, text data of a sentence “A coloring picture of a fox and a raccoon dog with autumn fruit as a background has been registered as a favorite image”. The text data is converted into voice data by the voice processing server 420, and is output as voice from the voice input/output device 410 in step S610.

Subsequently, the flow of the processing at the time when printing of a favorite image is performed is explained with reference to FIG. 12. As illustrated in FIG. 12, the instruction information acquisition unit 111 of the information processing device 100 acquires print instruction information for instructing printing of a favorite image via the voice system 400 (the voice input/output device 410 and the voice processing server 420). Specifically, information acquired in steps S701, S705, and S711 explained below is equivalent to the registration instruction information. In particular, the information acquired in step S705 is equivalent to the favorite specifying information explained above.

In step S700, the user U utters, for example, “Please print a favorite” to the voice input/output device 410. This voice is subjected to voice recognition processing by the voice processing server 420. In step S701, the voice processing server 420 transmits, to the information processing device 100, print instruction information for instructing printing of a favorite image. The instruction information acquisition unit 111 of the information processing device 100 acquires the information.

Subsequently, in step S702, the user interface processing unit 120 transmits text data of a sentence “It is a favorite. What kind of a picture the favorite is?” to the voice processing server 420 as a response to the print instruction information acquired in step S701. The text data is converted into voice data by the voice processing server 420 and is output as voice from the voice input/output device 410 in step S703.

In step S704, the user U utters, for example, “a fox and a raccoon dog” to the voice input/output device 410. This voice is subjected to a voice recognition processing by the voice processing server 420. In step S705, the instruction information acquisition unit 111 acquires information such as a “fox” and a “raccoon dog” as information for specifying a favorite image.

Subsequently, in step S706, the image acquisition unit 115 refers to the storage 300 and finds, from the storage 300, an image specified by the information acquired in step S705 among the images stored as the favorite images. Specifically, for example, the image acquisition unit 115 finds an image by referring to the tag information. Note that, in the example explained here, the information “fox” and “raccoon dog” is used as the favorite specifying information. However, as explained above, the identification information of the user U may be used, or information indicating a registration point in time of the favorite image may be used. In step S707, the image acquisition unit 115 acquires the image specified by the information acquired in step S705 from the storage 300.

Subsequently, in step S708, as a response to the print instruction information acquired in step S705, the user interface processing unit 120 transmits text data of a sentence “A coloring picture of a fox and a raccoon dog with autumn fruit as a background has been found. Print the coloring picture?” to the voice processing server 420. The text data is converted into voice data by the voice processing server 420 and is output as voice from the voice input/output device 410 in step S709.

In step S710, the user U utters, for example, “Yes” to the voice input/output device 410. This voice is subjected to a voice recognition processing by the voice processing server 420. In step S711, the voice processing server 420 transmits, to the information processing device 100, information indicating that the found favorite image is reliably an image that should be printed. The instruction information acquisition unit 111 of the information processing device 100 acquires the information.

Thereafter, in steps S712 to S715, processing of printing the image acquired from the storage 300 with the image forming device 200 is performed. Since the processing in step S712 to step S715 is the same as the processing in step S120 to step S123 illustrated in FIG. 3B, explanation of the processing is omitted.

In the example illustrated in FIG. 12, as the candidate of the print target image, one favorite image is found. However, a plurality of favorite images are sometimes found. When a plurality of favorite images are found, the list output unit 118 may output a list in which a plurality of different images stored as favorite images in the storage 300 are listed as print candidates. The list is output in this way, whereby the user U can check the favorite images of the print candidates. Therefore, convenience is improved.

In the present modification as well, the number of times an image stored in a storage 300 as a favorite image was printed may be stored in correlation with the image. In that case, the list output unit 118 may output a list in which the number of times of printing of each of the listed images is described. The list output unit 118 may output a list in which the listed images are sorted according to the number of times of printing. Specifically, a list in which an image having a larger number of times of printing is listed higher may be output. In the present modification as well, the list to be output may include code images for accessing the listed images. When the list is output, the print control unit 119 causes the image forming device 200 to execute printing of an image selected by the user U among the listed plurality of images.

When a favorite image that should be a printing candidate is not stored in the storage 300, for example, when the image specified by the favorite specifying information is not stored in the storage 300 as a favorite image, the user interface processing unit 120 may output error information indicating that a printing target favorite image is not found. Accordingly, the user U can easily grasp occurrence of an error.

When the image specified by the favorite specifying information is not stored in the storage 300 as a favorite image, a list explained below may be output instead of the output of the error information or together with the output of the error information. That is, the list output unit 118 may generate and output a list in which images stored in the storage 300 and printed by the user U in the past are listed. In this case, it is assumed that the print instruction information includes the identification information of the user U and the storage control unit 117 causes the storage 300 to store an image printed based on the print instruction information in correlation with the identification information included in the print instruction information. When the image specified by the favorite specifying information is not stored in the storage 300 as a favorite image, the list output unit 118 outputs a list in which images stored in correlation with the same identification information as the identification information included in the print instruction information for instructing printing of a favorite image are listed. Then, the print control unit 119 causes the image forming device 200 to execute printing of an image selected by the user U among the listed images. For example, the list output unit 118 may generate and output a list in which a predetermined number of images are listed in order from an image having the latest print history among the images stored in the storage 300 and printed by the user U in the past. As explained above, when the image specified by the favorite specifying information is not stored in the storage 300 as a favorite image, by outputting a list of images printed by a user in the past, an image that is a favorite of the user but is forgot to be registered can be printed. Therefore, convenience is improved. Note that the list that is output when the image specified by the favorite specifying information is not stored in the storage 300 as a favorite image may include code images for accessing the listed images or may include the number of times of printing of the listed images.

In the modification 3 explained above, an example in which an image acquired from another device such as the image generation AI server 500 is registered as a favorite image is explained. However, an image registered as a favorite image does not always have to be an image acquired from another device and may be, for example, an image stored in advance in the storage 300.

The embodiment and the several modifications are explained above. Among the embodiment and the modifications, in particular, in the configuration explained as the modification 2, only when the image corresponding to the print instruction information acquired by the instruction information acquisition unit 111 is not stored in the storage 300, the processing of acquiring the image from the other device (the generation AI server 500) based on the print instruction information is performed. With such a configuration, cases in which processing for acquiring an image using the other device is used are limited and it is possible to reduce the number of times the user U is kept waiting for a long time.

In the present disclosure, the embodiment and the several modifications are explained. However, the present disclosure is not limited to the embodiment and the modifications explained above and can be changed as appropriate without departing from the gist. For example, the characteristics explained as the embodiment or the modifications can be combined as appropriate. For example, in the embodiment and the modifications explained above, an instruction from the user U is acquired by voice input. However, an instruction from the user U may be acquired using an input device such as a button or a pointing device that receives input operation from the user U. The processing unit 116 may perform image processing on any image stored in the storage 300 for re-printing such as a favorite image according to an instruction of the user U.

For example, in the embodiment and the modifications explained above, the image request unit 114 of the information processing device 100 requests an image from the image generation AI server 500. However, the image request unit 114 may request an image from any device (server) other than the information processing device 100. For example, the image request unit 114 may request an image from a search server that searches for an image on the Internet. In this case, the image request unit 114 transmits, for example, information for designating a drawing target or a drawing mode to the search server as a search query. That is, the image request unit 114 transmits, to the search server, a search query using print instruction information acquired by the instruction information acquisition unit 111. Then, the image acquisition unit 115 may acquire an image found by search processing of the search server. The text generation AI server 600 may be used to obtain a search query. That is, the text request unit 112 and text acquisition unit 113 may execute processing of acquiring text (a search query) to be transmitted to the search server. Accordingly, it can be expected to easily acquire an appropriate search query compared with when a search query is generated from print instruction information on a rule basis. Also when the search server is used, search processing sometimes takes time. For this reason, it is likely that the user U is kept waiting for a long time until an image is printed. Therefore, even when the search server is used instead of the image generation AI server 500, it is useful to restrict the processing of acquiring an image from another device (the search server) as in the modification 2.

Note that the element (the server, the device, or the like) of the printing system 10 or 10a explained in the embodiment or the modifications explained above may be configured as a computer like the information processing device 100. That is, the elements of the printing system may include a memory and a processor. The processor may read a program from the memory and execute the program to implement the processing explained above.

The program includes an instruction group (or software codes) that causes a computer to provide one or more of the functions described in the embodiment when the program is loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or devices based on other memory technologies, a CD-ROM, a digital versatile disc (DVD), a Blu-ray (trademark registered) disc or other optical disc storages, a magnetic cassette, a magnetic tape, a magnetic disk storage or other magnetic storage devices. The program may be transmitted via a transitory computer-readable medium or a communication medium. Not as a limitation but as an example, the transitory computer-readable medium or the communication medium include a propagation signal of an electric, optical, acoustic, or another form.

A part or the entire embodiment or the modifications explained above can also be described as indicated by the following appendixes but is not limited to the following.

### Appendix 1

An information processing device including:
an instruction information acquisition unit configured to acquire first print instruction information including designation of a drawing target;
an image request unit configured to, when an image corresponding to the acquired first print instruction information is not stored in a storage, request, using the first print instruction information, another server to transmit an image in which the drawing target is drawn;
an image acquisition unit configured to acquire the image from the other server; and
a print control unit configured to cause an image forming device to print the acquired image.

### Appendix 2

The information processing device described in the appendix 1, wherein
the other server is an image generation AI server,
the image request unit transmits an image generation instruction generated based on the first print instruction information to the image generation AI server in order to request the image generation AI server to transmit the image in which the drawing target is drawn, and
the image acquisition unit acquires, from the image generation AI server, an image generated by the image generation AI server based on the image generation instruction.

### Appendix 3

The information processing device described in the appendix 1 or 2, wherein the instruction information acquisition unit acquires the first print instruction information input as voice by a user.

### Appendix 4

The information processing device described in any one of the appendixes 1 to 3, further including a storage control unit configured to cause the storage to store an image acquired from the other server in correlation with tag information obtained from the first print instruction information used to acquire the image, wherein
the instruction information acquisition unit acquires second print instruction information including the designation of the drawing target,
when an image stored in correlation with tag information corresponding to the second print instruction information is absent in the storage, the image request unit requests, using the second print instruction information, the other server to transmit the image in which the drawing target is drawn, and
when the image stored in correlation with the tag information corresponding to the second print instruction information is present in the storage, the print control unit causes the image forming device to execute printing of the image acquired from the storage.

### Appendix 5

The information processing device described in the appendix 4, wherein
the first print instruction information and the second print instruction information further include identification information of a user,
the storage control unit causes the storage to store the image acquired from the other server in correlation with the tag information and the identification information included in the first print instruction information used to acquire the image,
when an image stored in correlation with the identification information included in the second print instruction information and the tag information corresponding to the second print instruction information is absent in the storage, the image request unit requests, using the second print instruction information, the other server to transmit the image in which the drawing target is drawn, and
when the image stored in correlation with the identification information included in the second print instruction information and the tag information corresponding to the second print instruction information is present in the storage, the print control unit causes the image forming device to execute printing of the image acquired from the storage.

### Appendix 6

The information processing device described in the appendix 4, wherein
the first print instruction information and the second print instruction information further include identification information of a user,
the storage control unit causes the storage to store the image acquired from the other server in correlation with the tag information and the identification information included in the first print instruction information used to acquire the image,
when the image stored in correlation with the tag information corresponding to the second print instruction information is absent in the storage, the image request unit requests, using the second print instruction information, the other server to transmit the image in which the drawing target is drawn, and
when an image stored in correlation with the identification information included in the second print instruction information and the tag information corresponding to the second print instruction information is present in the storage or when an image stored in correlation with identification information of the user different from the identification information included in the second print instruction information and the tag information corresponding to the second print instruction information is present in the storage, the print control unit causes the image forming device to execute printing of the image acquired from the storage.

### Appendix 7

The information processing device described in any one of the appendixes 1 to 6, wherein
the image acquisition unit acquires, from the other server, a plurality of different images as images in which the drawing target is drawn, and
the information processing device further includes a list output unit configured to output a list in which the plurality of different images are listed as print candidates.

### Appendix 8

The information processing device described in the appendix 7, further including a storage control unit configured to cause the storage to store the image acquired by the image acquisition unit, wherein
the list to be output includes a code image obtained by encoding information indicating an access destination for acquiring a listed image from the storage.

### Appendix 9

The information processing device described in the appendix 7 or 8, wherein the list to be output includes a number of times of printing of each of the listed images.

### Appendix 10

The information processing device described in any one of the appendixes 7 to 9, wherein
the instruction information acquisition unit further acquires an instruction to select the print target from the plurality of different images listed in the list, and
the print control unit causes the image forming device to print a selected image among the plurality of different images.

### Appendix 11

The information processing device according to any one of the appendixes 1 to 10, wherein, when the acquired first print instruction information includes an instruction to print a new image, regardless of whether an image corresponding to the acquired first print instruction information is stored in the storage, the image request unit requests, using the first print instruction information, the other server to transmit the image in which the drawing target is drawn.

### Appendix 12

An information processing method including:
acquiring first print instruction information including designation of a drawing target;
when an image corresponding to the acquired first print instruction information is not stored in a storage, requesting, using the first print instruction information, another server to transmit an image in which the drawing target is drawn;
acquiring the image from the other server; and
causing an image forming device to print the acquired image.

### Appendix 13

A non-transitory computer-readable storage medium storing a program, the program causing a computer to execute:
an instruction information acquisition step of acquiring first print instruction information including designation of a drawing target;
an image request step of, when an image corresponding to the acquired first print instruction information is not stored in a storage, requesting, using the first print instruction information, another server to transmit an image in which the drawing target is drawn;
an image acquisition step of acquiring the image from the other server; and
a print control step of causing an image forming device to print the acquired image.

What is claimed is:

1. An information processing device comprising:
an instruction information acquisition unit configured to acquire first print instruction information including designation of a drawing target;
an image request unit configured to, when an image corresponding to the acquired first print instruction information is not stored in a storage, request, using the first print instruction information, another server to transmit an image in which the drawing target is drawn;
an image acquisition unit configured to acquire the image from the other server; and
a print control unit configured to cause an image forming device to print the acquired image.

2. The information processing device according to claim 1, wherein
the other server is an image generation AI server,
the image request unit transmits an image generation instruction generated based on the first print instruction information to the image generation AI server in order to request the image generation AI server to transmit the image in which the drawing target is drawn, and
the image acquisition unit acquires, from the image generation AI server, an image generated by the image generation AI server based on the image generation instruction.

3. The information processing device according to claim 1, wherein the instruction information acquisition unit acquires the first print instruction information input as voice by a user.

4. The information processing device according to claim 1, further comprising a storage control unit configured to cause the storage to store an image acquired from the other server in correlation with tag information obtained from the first print instruction information used to acquire the image, wherein
the instruction information acquisition unit acquires second print instruction information including the designation of the drawing target,
when an image stored in correlation with tag information corresponding to the second print instruction information is absent in the storage, the image request unit requests, using the second print instruction information, the other server to transmit the image in which the drawing target is drawn, and
when the image stored in correlation with the tag information corresponding to the second print instruction information is present in the storage, the print control unit causes the image forming device to execute printing of the image acquired from the storage.

5. The information processing device according to claim 4, wherein
the first print instruction information and the second print instruction information further include identification information of a user,
the storage control unit causes the storage to store the image acquired from the other server in correlation with the tag information and the identification information included in the first print instruction information used to acquire the image,
when an image stored in correlation with the identification information included in the second print instruction information and the tag information corresponding to the second print instruction information is absent in the storage, the image request unit requests, using the second print instruction information, the other server to transmit the image in which the drawing target is drawn, and
when the image stored in correlation with the identification information included in the second print instruction information and the tag information corresponding to the second print instruction information is present in the storage, the print control unit causes the image forming device to execute printing of the image acquired from the storage.

6. The information processing device according to claim 4, wherein
the first print instruction information and the second print instruction information further include identification information of a user,
the storage control unit causes the storage to store the image acquired from the other server in correlation with the tag information and the identification information included in the first print instruction information used to acquire the image,
when the image stored in correlation with the tag information corresponding to the second print instruction information is absent in the storage, the image request unit requests, using the second print instruction information, the other server to transmit the image in which the drawing target is drawn, and
when an image stored in correlation with the identification information included in the second print instruction information and the tag information corresponding to the second print instruction information is present in the storage or when an image stored in correlation with identification information of the user different from the identification information included in the second print instruction information and the tag information corresponding to the second print instruction information is present in the storage, the print control unit causes the image forming device to execute printing of the image acquired from the storage.

7. The information processing device according to claim 1, wherein
the image acquisition unit acquires, from the other server, a plurality of different images as images in which the drawing target is drawn, and
the information processing device further comprises a list output unit configured to output a list in which the plurality of different images are listed as print candidates.

8. The information processing device according to claim 7, further comprising a storage control unit configured to cause the storage to store the image acquired by the image acquisition unit, wherein
the list to be output includes a code image obtained by encoding information indicating an access destination for acquiring a listed image from the storage.

9. The information processing device according to claim 7, wherein the list to be output includes a number of times of printing of each of the listed images.

10. The information processing device according to claim 7, wherein
the instruction information acquisition unit further acquires an instruction to select the print target from the plurality of different images listed in the list, and
the print control unit causes the image forming device to print a selected image among the plurality of different images.

11. The information processing device according to claim 1, wherein, when the acquired first print instruction information includes an instruction to print a new image, regardless of whether an image corresponding to the acquired first print instruction information is stored in the storage, the image request unit requests, using the first print instruction information, the other server to transmit the image in which the drawing target is drawn.

12. An information processing method comprising:
acquiring first print instruction information including designation of a drawing target;
when an image corresponding to the acquired first print instruction information is not stored in a storage, requesting, using the first print instruction information, another server to transmit an image in which the drawing target is drawn;
acquiring the image from the other server; and
causing an image forming device to print the acquired image.

13. A non-transitory computer-readable storage medium storing a program, the program causing a computer to execute:
an instruction information acquisition step of acquiring first print instruction information including designation of a drawing target;
an image request step of, when an image corresponding to the acquired first print instruction information is not stored in a storage, requesting, using the first print instruction information, another server to transmit an image in which the drawing target is drawn;
an image acquisition step of acquiring the image from the other server; and
a print control step of causing an image forming device to print the acquired image.
